(19) United States
(12) Patent Application Publication
(10) Pub. No.: US 2021/0320371 A1
(43) Pub. Date: Oct. 14, 2021

(54) INTERCONNECTED BATTERY MODULE SYSTEMS, ASSEMBLIES AND METHODS

(71) Applicant: Electric Power Systems, Inc., North Logan, UT (US)

(72) Inventors: Randy Dunn, Orange, CA (US); James Banwell, Montclair, CA (US); Cory J. Newman, Providence, UT (US); Joseph James, Logan, UT (US); Michael Armstrong, North Logan, UT (US)

(73) Assignee: Electric Power Systems, Inc., North Logan, UT (US)

(21) Appl. No.: 17/227,234

(22) Filed: Apr. 9, 2021

Related U.S. Application Data
(60) Provisional application No. 63/008,537, filed on Apr. 10, 2020.
(60) Provisional application No. 63/145,275, filed on Feb. 3, 2021.

(51) Int. Cl. H01M 50/264; H01M 50/30; H01M 50/578; H01M 50/502; H01M 50/179

(52) U.S. Cl. CPC H01M 50/264; H01M 50/30; H01M 50/179; H01M 50/502; H01M 50/578

(57) ABSTRACT

An interconnected battery module comprises an enclosure and a plurality of cells. The interconnected battery module may be configured to be electrically and physically coupled to an adjacent interconnected battery module without wires or wiring harnesses. A battery system with the interconnected battery modules may manage a thermal runaway event within one of the interconnected battery modules by preventing propagation to a remainder of interconnected battery modules.

### CROSS-REFERENCE TO RELATED APPLICATIONS

This application is a non-provisional of, and claims priority to, and the benefit of U.S. Provisional Application No. 63/008,537, entitled “INTERCONNECTED BATTERY MODULE SYSTEMS, ASSEMBLIES AND METHODS,” filed on Apr. 10, 2020 and U.S. Provisional Application No. 63/145,275 entitled “INTERCONNECTED BATTERY MODULE SYSTEMS, ASSEMBLIES AND METHODS,” filed on Feb. 3, 2021, both of which are hereby incorporated by reference in their entirety.

### FIELD OF INVENTION

The present disclosure generally relates to apparatus, systems and methods for providing interconnected battery modules.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected cell-brick assemblies. These cell-brick assemblies may, in turn, include a parallel, series, or combination of both, collection of electrochemical or electrostatic cells hereafter referred to collectively as “cells”, that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Such cells are mass produced, driven by an ever-increasing consumer market that demands low cost rechargeable energy for portable electronics.

Custom battery solutions may be expensive for a respective customer. Custom battery solutions may include longer lead times due to the customization desired by the customer. Custom battery solutions may be engineering intensive to meet desired characteristics by a customer.

### SUMMARY OF THE INVENTION

In an example embodiment, an interconnected battery module is disclosed herein. The interconnected battery module may include a plurality of battery cells disposed in an enclosure. The interconnected battery module may be adaptive and configurable to any parallel and/or series configuration. A first interconnected battery module may be coupled to an adjacent interconnected battery module to form an interconnected battery module system. The adjacent interconnected battery module may be in accordance with the first interconnected battery module. The first interconnected battery module and the adjacent interconnected battery module may be connected in series or parallel.

In an example embodiment, an interconnected battery module may comprise an enclosure and a plurality of cells disposed within the enclosure. The cold plate may comprise a fluid inlet and a fluid outlet. The enclosure may comprise a composite, such as a cured polymer matrix composite (PMC) comprised of fiber composite and a resin matrix. The cured PMC may include thermoset polyimide resin mixture or a thermoset cyanate resin mixture having glass transition temperatures greater than 500 degree F. The interconnected battery module may be configured to contain a thermal runaway event of the plurality of cells within the enclosure.

In an example embodiment, an interconnected battery module may include an electrical connector assembly. The electrical connector assembly may be configured to mechanically and electrically couple the interconnected battery module to an adjacent interconnected battery module. In an example embodiment, the electrical connector assembly may facilitate connections between battery modules without the use of wire harnesses, or the like.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and where:

FIG. 1 illustrates an interconnected battery module system, in accordance with various embodiments;

FIG. 2 illustrates a perspective view of a cold plate, in accordance with various embodiments;

FIG. 3 illustrates a perspective view of a portion of an interconnected battery module during assembly, in accordance with various embodiments;

FIG. 4A illustrates a perspective view of a portion of an interconnected battery module during assembly, in accordance with various embodiments;

FIG. 4B illustrates a perspective view of a portion of an interconnected battery module during assembly, in accordance with various embodiments;

FIG. 5 illustrates a perspective view of an enclosure, in accordance with various embodiments;

FIG. 6 illustrates an exploded view of an interconnected battery module, in accordance with various embodiments;

FIG. 7 illustrates a cross-sectional view of an interconnected battery module, in accordance with various embodiments;

FIG. 8 illustrates a perspective view of an interconnected battery module, in accordance with various embodiments;

FIG. 9 illustrates a perspective view of an interconnected battery module, in accordance with various embodiments;

FIG. 10 illustrates a perspective view of an interconnected battery module, in accordance with various embodiments;

FIG. 11 illustrates a cross-sectional view of an interconnected battery module system, in accordance with various embodiments;

FIGS. 12A and 12B each illustrate a cross-sectional view of a washer for use in an interconnected battery module system, in accordance with various embodiments; and

FIG. 13 illustrates a method for coupling a first interconnected battery module to a second interconnected battery module in an interconnected battery module system, in accordance with various embodiments;

FIG. 14 illustrates a perspective view of an interconnected battery module, in accordance with various embodiments;

FIG. 15 illustrates a cross-sectional view of an interconnected battery module, in accordance with various embodiments;

FIG. 16A illustrates a perspective cross-sectional view of a portion of an interconnected battery module, in accordance with various embodiments;

FIG. 16B illustrates a perspective exploded view of a portion of an interconnected battery module prior to assembly, in accordance with various embodiments;

FIG. 16C illustrates a perspective cross-sectional view of a portion of an interconnected battery module, in accordance with various embodiments;

FIG. 16D illustrates a perspective view of a portion of an interconnected battery module, in accordance with various embodiments;

FIG. 16E illustrates a perspective cross-sectional view of a portion of an interconnected battery module, in accordance with various embodiments;

FIG. 16F illustrates a perspective exploded view of a portion of an interconnected battery module, in accordance with various embodiments;

FIG. 17 illustrates an interconnected battery module system, in accordance with various embodiments;

FIG. 18A illustrates a perspective view of an electrical connector assembly, in accordance with various embodiments;

FIG. 18B illustrates a cross-sectional view of an electrical connector assembly, in accordance with various embodiments;

FIG. 18C illustrates a side view of an electrical connector assembly, in accordance with various embodiments; and

FIG. 19 illustrates a perspective view of a vent for an interconnected battery module, in accordance with various embodiments.

### DETAILED DESCRIPTION

The following description is of various example embodiments only, and is not intended to limit the scope, applicability, or configuration of the present disclosure in any way. Rather, the following description is intended to provide a convenient illustration for implementing various embodiments including the best mode. As will become apparent, various changes may be made in the function and arrangement of the elements described in these embodiments, without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent example functional relationships and/or physical couplings between various elements. It should be noted that many alternative or additional functional relationships or physical connections may be present in a modular structure.

In an example embodiment, an interconnected battery module may comprise a plurality of cells connected in series or parallel disposed in an enclosure. The interconnected battery module may be configured to electrically and mechanically couple to an adjacent interconnected battery module that is in accordance with the interconnected battery module. The interconnected battery module is configured to facilitate an electrical connection between interconnected battery modules without the use of wires (i.e., hard electrical interfaces without wires), in accordance with various embodiments.

In an example embodiment, a battery system may comprise a plurality of the interconnected battery modules. Each interconnected battery module in the interconnected battery module system may be configured to be electrically coupled to an adjacent interconnected battery module in the plurality of interconnected battery modules in series or in parallel. In this regard, the interconnected battery module system may be customizable and adaptable to various configurations to supply a customized voltage and/or current as desired by an end user. In an example embodiments, the plurality of interconnected battery modules may be stackable (i.e., the plurality of interconnected battery modules may form a string of interconnected battery modules in the battery system.

In an example embodiment, the cooling plate may be configured to structurally support the plurality of cells. In this regard, the cooling plate may eliminate structural elements typically used to support a plurality of cells in a typical battery module, such as latticework, excess tape, or the like. As such, the cooling plate acting as a structural element may allow for a reduced weight of the interconnected battery module relative to typical battery modules. The cooling plate may comprise a cooling channel disposed therethrough. The cooling channel may include an inlet and an outlet disposed proximate a first end of the cooling plate. In various embodiments, the inlet and the outlet may be disposed on opposite ends. The cooling plate may comprise a plurality of contoured portions. Each contour portion may comprise a complimentary shape to a portion of a battery cell. For example, a contour portion may comprise an arcuate shape configured to interface with a portion of an outer diameter surface of a cylindrical cell in the plurality of cells. In an example embodiment, each cell in the plurality of cells may be coupled to a respective contoured portion of the cooling plate by an adhesive, such as epoxy or the like.

In an example embodiment, the interconnected battery module may comprise an enclosure configured to house the plurality of cells and the cooling plate. The enclosure may be made of any material. In various embodiments, the enclosure is made of a composite material, such as a fiberglass and a synthetic fiber material (e.g., a synthetic fiber available under the trademark Kevlar®), or the like. In this regard, the composite material may provide enhanced thermal runaway protection by having greater thermal resistance relative to typical enclosure materials (e.g., aluminum and stainless steel). The interconnected battery module may comprise a first terminal and a second terminal. Each terminal may be configured to couple to an adjacent terminal from an adjacent interconnected battery module in series or in parallel, as discussed further herein. In various embodiments, the first terminal and the second terminal may also provide structural support in an interconnected battery module system. Furthermore, an interconnected battery module system, in accordance with an example embodiment, may provide enhanced protection from thermal runaway. In this regard, the interconnected battery module system may isolate a thermal runaway event in a single interconnected battery module of the interconnected battery module system and/or prevent the thermal runaway event from propagating to adjacent interconnected battery modules in the system.

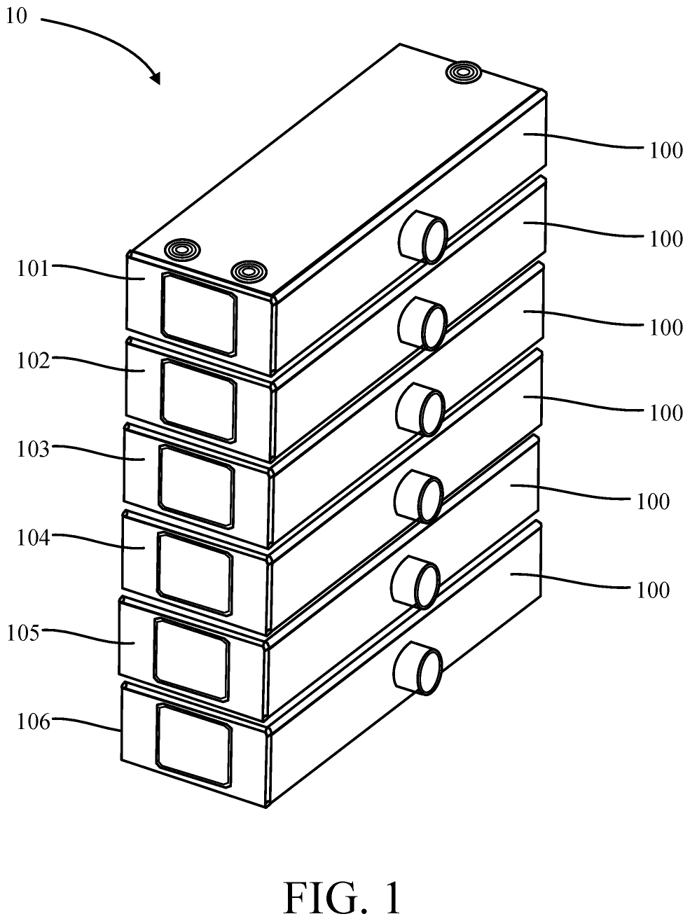

Referring now to FIG. 1, an interconnected battery module system 10 is illustrated, in accordance with various embodiments. The interconnected battery module system 10 comprises a plurality of interconnected battery modules 100. Each interconnected battery module in the plurality of interconnected battery modules 100 is electrically and physically coupled to an adjacent interconnected battery module in the plurality of interconnected battery modules 100. For example, the first interconnected battery module 101 is coupled to the second interconnected battery module 102. The third interconnected battery module 103 is coupled to the second interconnected battery module 102 and the fourth interconnected battery module 104. The fifth interconnected battery module 105 is coupled to the fourth interconnected battery module 104 and the sixth interconnected battery module 106. Although illustrated with six interconnected battery modules, a battery module system comprising any number of interconnected battery modules 100 is within the scope of this disclosure. For example, the number of interconnected battery modules 100 may be customized based on a desired voltage and/or current for a particular battery application.

In various embodiments, each interconnected battery module in the plurality of interconnected battery modules 100 may be coupled to an adjacent interconnected battery module in the plurality of interconnected battery modules 100 in series or in parallel. In this regard, a positive terminal may be adaptable to couple to either a negative terminal or a positive terminal of an adjacent battery module in the plurality of battery modules 100, as described further herein.

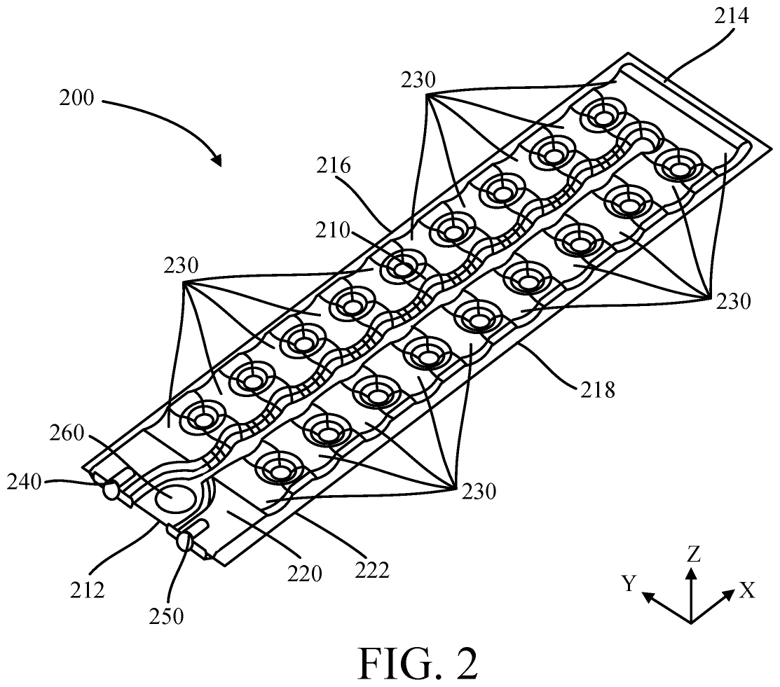

Referring now to FIG. 2, a cold plate for use in an interconnected battery module (e.g., interconnected battery module 101, or the like), is illustrated, in accordance with various embodiments. In various embodiments, a cold plate 200 comprises an elongated plate 210 extending from a first end 212 to a second end 214 and defining an elongation direction (e.g., X-direction). Although described herein as a “cold plate,” it is within the scope of this disclosure that cold plate 200 may be used for heating battery cells, as well as cooling battery cells.

In various embodiments, the cold plate 200 further comprises a plurality of contour portions 230 disposed in a first side 220 of the elongated plate 210. Each contour portion in the plurality of contour portions 230 may be defined by an arcuate recess disposed in first side 220 in a plate thickness direction (e.g., Z-direction). In various embodiments, each contour portion in the plurality of contour portions 230 may be disposed adjacent to an adjacent contour portion in the plurality of contour portions 230. In this regard, the cold plate 200 may be configured to receive a plurality of cells arranged in a row on first side 220 of the elongated plate 210. Each contour portion in the plurality of contour portions 230 may be configured to maximize a surface area of a respective cell from a plurality of cells that mates with the respective contour portion in the plurality of contour portions 230. Additional surface area may provide additional heat transfer from the cold plate 200 to the respective cell in the plurality of cells.

In various embodiments, the cold plate 200 comprises a fluid inlet 240 and a fluid outlet 250. The fluid inlet 240 and the fluid outlet 250 may both be disposed at the first end 212 of the elongated plate 210. Although fluid inlet 240 and fluid outlet 250 are both illustrated at first end 212 of the elongated plate 210, having a fluid inlet at the first end 212 and a fluid outlet at second end 214 is within the scope of this disclosure. In various embodiments, the fluid inlet 240 and the fluid outlet 250 are in fluid communication via a fluid channel extending through the elongated plate 210. The fluid channel may extend from first end 212 to second end 214 proximate a bottom end 216, serpentine at second end 214, and extend back from second end 214 to first end 212 on a top end 218. The top end 218 is opposite the bottom end 216 in a width direction (e.g., Y-direction). In various embodiments, when a fluid inlet and a fluid outlet are disposed at opposite ends, the fluid channel may extend only from first end 212 to second end 214.

In various embodiments, a second side 222 of the cold plate 200 may mirror the first side 220 of the cold plate through a center plane defined by the elongation direction (e.g., X-direction) and the width direction (e.g., Y-direction). The second side 222 may be in accordance with the first side 220. In this regard, the second side 222 may be configured to receive a second row of cells, similar to first side 220.

In various embodiments, the cold plate 200 further comprises a mounting aperture 260. The mounting aperture 260 may be disposed proximate the first end 212. The mounting aperture 260 may be disposed between fluid inlet 240 and fluid outlet 250. Although illustrated at first end 212, the mounting aperture 260 may be disposed proximate second end 214, in accordance with various embodiments. The mounting aperture 260 may be configured to couple the cold plate 200 to a respective enclosure of an interconnected battery module (e.g., first interconnected battery module 101 or the like).

In various embodiments, cold plate 200 may be manufactured via extrusion, casting, additive manufacturing, or any other method known in the art. In various embodiments, the cold plate 200 may comprise aluminum, titanium, stainless steel, or any other material known in the art. In various embodiments, the cold plate 200 comprises aluminum. In various embodiments, the cooling plate may include a dielectric barrier, such as polyimide tape, or any other dielectric barrier known in the art. In various embodiments, polyimide tape may provide enhanced thermal protection for a respective interconnected battery module (e.g., interconnected battery module 101, 102, etc.).

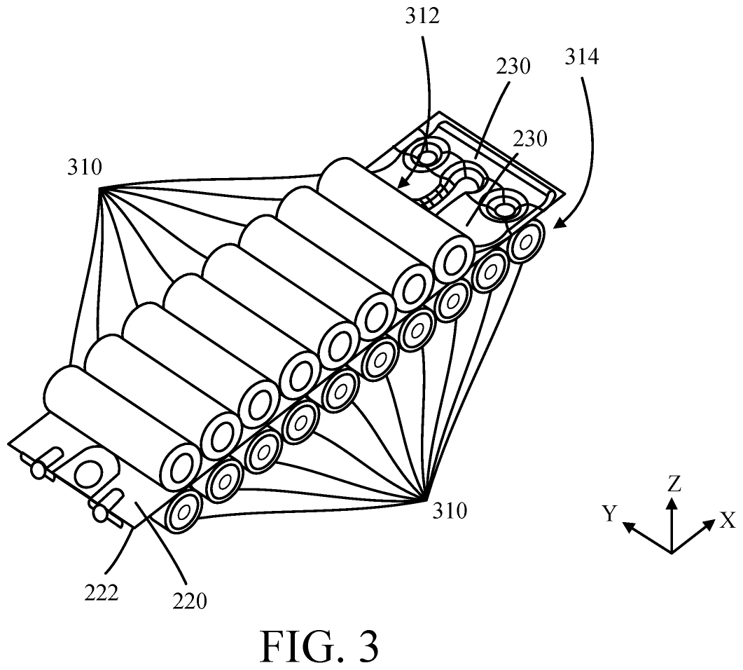

Referring now to FIG. 3, a portion of an interconnected battery module during assembly is illustrated, in accordance with various embodiments. In various embodiments, a plurality of cells 310 are coupled to the cold plate 200. Each cell in the plurality of cells 310 may be cylindrical in shape. The plurality of cells 310 may be disposed in a first row of cells 312 disposed on first side 220 of cold plate 200 and a second row of cells 314 disposed on second side 222 of cold plate 200. Each cell in the plurality of cells 310 may be disposed adjacent to an adjacent cell in the plurality of cells 310 in the elongation direction (e.g., the X-direction).

In various embodiments, each cell in the plurality of cells 310 is disposed in a respective contour portion in the plurality of contour portions 230. In this regard, a surface area of the cold plate 200 contacting a respective cell in the plurality of cells 310 is maximized. By having a greater amount of surface area of the cold plate 200 in contact with each cell in the plurality of cells 310, heat transfer between the cold plate 200 and each cell during operation may be increased relative to typical battery modules.

In various embodiments, each cell in the plurality of cells 310 may have a polymer wrapping around the cell removed (i.e., “unstripped”). Each cell in the plurality of cells 310 may be coupled to a respective contour portion in the plurality of contour portions 230 by an adhesive, such as epoxy, or any other adhesive known in the art. The cold plate 200 may act as a structural support for the plurality of cells 310. In this regard, the cold plate 200 may eliminate additional structural elements, such as structural latticework of typical battery modules.

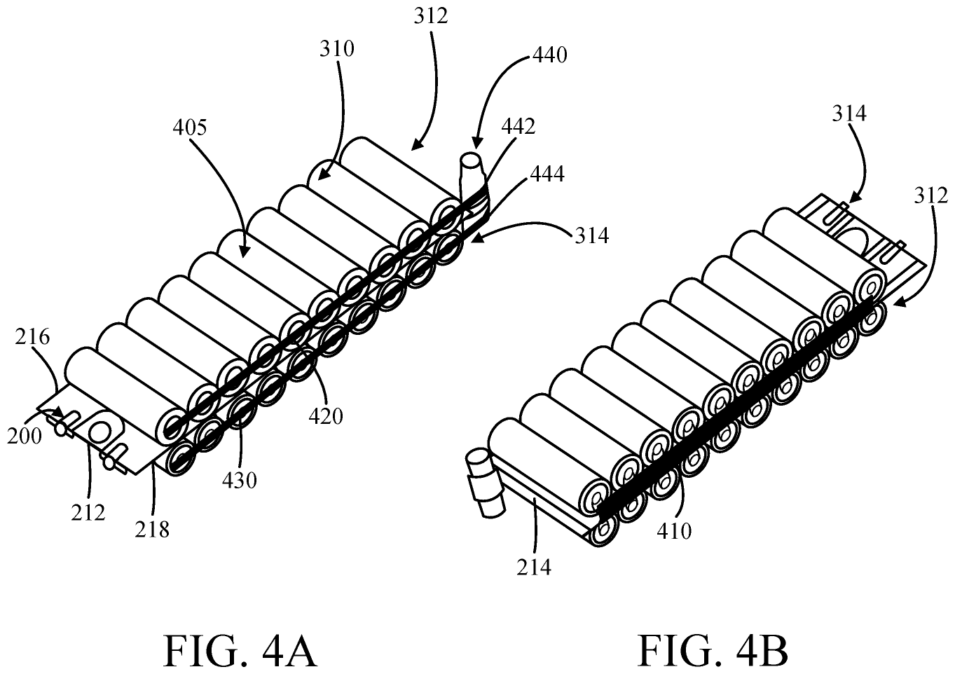

Referring now to FIGS. 4A and 4B, a portion of an interconnected battery module during assembly is illustrated, in accordance with various embodiments. In various embodiments, the plurality of cells 310 may form a cell brick assembly 405. The cell brick assembly 405 may comprise the first row of cells 312, the second row of cells 314, and the cold plate 200 disposed between the first row of cells 312 and the second row of cells 314. The cell brick assembly 405 may couple the plurality of cells 310 together in series, in parallel, or in a combination. In various embodiments, the first row of cells 312 is electrically coupled together in parallel, and the second row of cells 314 are coupled together in parallel. In various embodiments, the first row of cells 312 are coupled to the second row of cells 314 in series. For example, a first busbar 410 may be disposed proximate bottom end 216 of the cold plate 200, a second busbar 420 may be disposed proximate top end 218, and a third busbar 430 may be disposed proximate the top end 218.

The first busbar 410 may electrically couple a positive end of each cell in the first row of cells 312 to a negative end of each cell in the second row of cells 314. The second busbar 420 may electrically couple a negative end of each cell in the first row of cells together. The third busbar 430 may electrically couple a positive end of each cell in the second row of cells 314 together. The second busbar 420 may extend along the first row of cells 312 and electrically/physically couple the first row of cells to an electrical terminal 440. Similarly, the third busbar 430 may extend along the second row of cells 314 and electrically/physically couple the second row of cells 314 to the electrical terminal 440. The electrical terminal 440 may comprise a negative terminal 442 and a positive terminal 444. The negative terminal 442 may be coupled to the second busbar 420, and the positive terminal 444 may be coupled to the third busbar 430. The negative terminal 442 and the positive terminal 444 may be electrically isolated. Although the electrical terminal 440 is illustrated as being disposed proximate the second end 214 of the elongated plate 210, the electrical terminal 440 may be disposed proximate first end 212 of the elongated plate 210 in various embodiments.

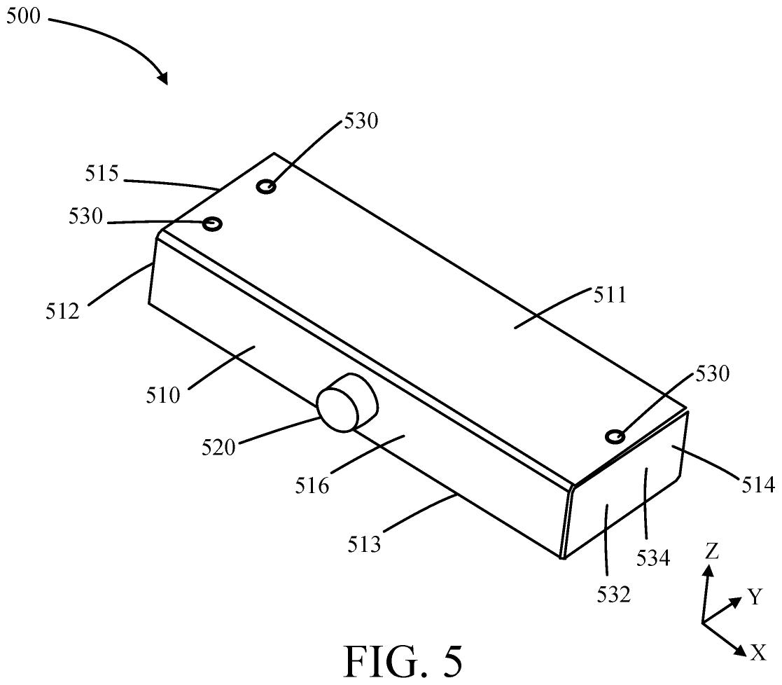

Referring now to FIG. 5, an enclosure 500 for use in an interconnected battery module (e.g., interconnected battery module 101, 102, etc.), is illustrated, in accordance with various embodiments. The enclosure 500 may comprise a housing 510 extending from a first end 512 to a second end 514. The housing 510 may comprise an opening 515 proximate the first end 512. The housing 510 may be configured to receive a cell brick assembly 405 as illustrated in FIGS. 4A and 4B. In accordance with various embodiments, an end plate may enclose the opening 515 of the housing 510 after a cell brick assembly 405 from FIGS. 4A AND 4B is disposed therein. The housing 510 may comprise a vent port 520 disposed at a first width end 516 of housing 510. The vent port 520 may be in fluid communication with an internal cavity of the housing 510. The vent port 520 may be configured to vent smoke from excess heat and ejecta during operation of an interconnected battery module, such as during a thermal runaway event, or the like. The housing 510 may further comprise a plurality of mounting apertures 530. Each mounting aperture in the plurality of mounting apertures 530 may be configured to receive a connector (e.g., an electrical connector assembly or a mechanical connector assembly as described further herein). Each aperture in the plurality of apertures 530 may extend through a first side housing 511 and a second side housing 513 of the housing 510.

In various embodiments, the enclosure 500 may further comprise a first fluid aperture 532 and a second fluid aperture 534. Each fluid aperture 532, 534 may be configured to receive a respective fluid port (e.g., fluid inlet 240 or fluid outlet 250 of cold plate 200 from FIG. 2). In various embodiments, the housing 510 may be substantially cubical in shape.

In various embodiments, the enclosure 500 may comprise a cured polymer matrix composite (PMC) comprised of fiber composite (e.g., fiberglass, synthetic fiber such as that sold under the trademark Kevlar®, or the like) and a resin matrix. In various embodiments, the PMC may include thermoset polyimide resin mixtures having glass transition temperatures greater than 500 degree F. In various embodiments, the PMC may include thermoset polyimide resin mixtures having glass transition temperatures between 500 degree F. and 2,220 degree F. In various embodiments, the PMC may include thermoset cyanate ester resin mixtures having glass transition temperatures greater than 500 degree F. In various embodiments, the PMC may include thermoset cyanate ester resin matrix having glass transition temperatures between 500 degree F. and 2,220 degree F. In this regard, the enclosure 500 the glass transition temperature may provide enhanced thermal runaway containment for an interconnected battery module system (e.g., interconnected battery module system 10 from FIG. 1) by containing a thermal runaway event of a cell within a respective interconnected battery module in the plurality of interconnected battery modules 100 (e.g., interconnected battery module 101, 102, etc.).

In various embodiments, the enclosure may be manufactured by wet winding (e.g., stringing fiberglass through a resin bath and wrapping it around a mandrel to create a profile of the enclosure 500), or by resin infusion molding (e.g., wrapping a fiberglass sheet around a mandrel, exposing the fiberglass to a vacuum, injecting the resin and curing the resin simultaneously).

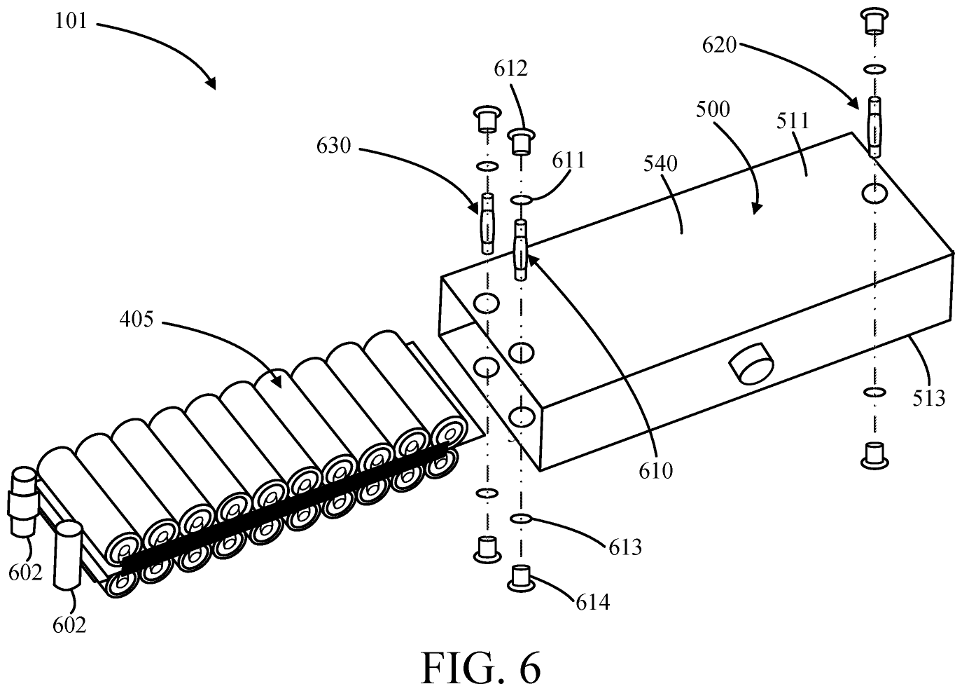

Referring now to FIG. 6, an exploded view of an interconnected battery module 101 for use in an interconnected battery module system 10 from FIG. 1, is illustrated, in accordance with various embodiments. The interconnected battery module 101 comprises the cell brick assembly 405, the enclosure 500, a first mechanical connector assembly 610, a second mechanical connector assembly 620, and an electrical connector assembly 630. Although illustrated with two mechanical connector assemblies and an electrical connector assembly, any number of mechanical connector assemblies and electrical connector assemblies may be utilized. For example, a single mechanical connector assembly and a single electrical connector assembly may be utilized, two electrical connector assemblies and a mechanical connector assembly may be utilized, or any other combination of electrical connector assemblies and mechanical connector assemblies is within the scope of this disclosure.

In various embodiments, the cell brick assembly 405 may further comprise a first column 602 disposed proximate the electrical terminal 440 proximate second end 214 of cold plate 200. Similarly, a column in accordance with first column 602 may be disposed through mounting aperture 260 of cold plate 200, and a third column 606 may be coupled to the electrical terminal 440. Each column 602, 606 may be configured to receive a connector assembly (e.g., connector assemblies 610, 620, 630).

In various embodiments, each connector assembly may comprise a positive connector and a negative connector. For example, first connector assembly 610 comprises a positive terminal 614 and a negative terminal 612. The positive terminal 614 may be configured to be coupled to a first elongated side 540 of enclosure 500. The negative terminal 612 may be configured to be coupled to a second elongated side 550 of the enclosure. As described further herein, the positive terminal 614 may comprise a protrusion and the negative terminal 612 may comprise a recess. The recess of the negative terminal 612 may be configured to interface with a protrusion of a positive terminal 614 of an adjacent interconnected battery module (e.g., interconnected battery module 101, 102, etc.) in a battery module system (e.g., interconnected battery module system 10 from FIG. 1). In various embodiments, each connector on the first side housing 511 may be the same, and each connector on the second side housing 513 may be the same. For example, first mechanical connector assembly 610, second mechanical connector assembly 620, and electrical connector assembly 630 may each comprise a connector in accordance with positive terminal 614 disposed on the first side housing 511 of the enclosure 500.

In various embodiments, each connector assembly may comprise a first seal and a second seal. For example, first connector assembly 610 may comprise a first seal 611 and second seal 613. The first seal 611 may be disposed between the positive terminal 614 and the first elongated side 540. Similarly, the second seal 613 may be disposed between the negative terminal 612 and the second elongated side 550. In various embodiments, the first seal 611 and the second seal 613 may each comprise an O-ring, or the like. In various embodiments, the first seal 611 and the second seal 613 may be made of an elastomer, such as rubber. In various embodiments, the first seal 611 and the second seal 613 may protect the electrical connection for the electrical terminal 440.

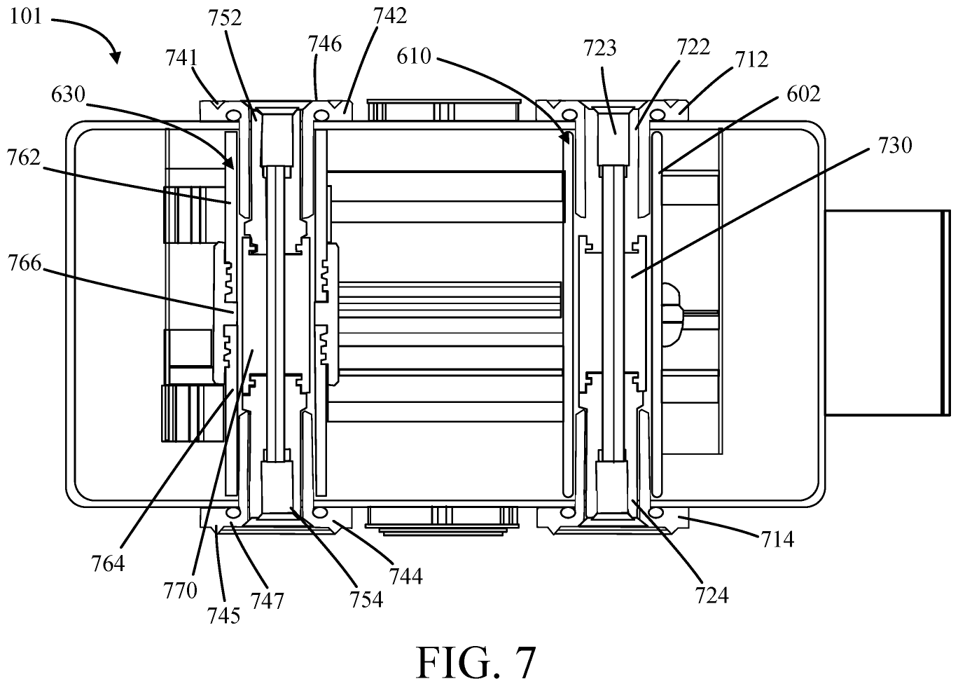

Referring now to FIG. 7, a cross-section of an assembled interconnected battery module 101, in accordance with various embodiments, is illustrated. The interconnected battery module 101 comprises first connector assembly 610 and electrical connector assembly 630. The first connector assembly 610 comprises first column 602, a negative terminal 712, a positive terminal 714, a first torque driver 722, a second torque driver 724, and a connector 730. The connector 730 may coupled the first torque driver 722 to the second torque driver 724. The first torque driver 722 may be configured to rotate within a tubular portion of the negative terminal 712 and the second torque driver 724 may be configured to rotate within a tubular portion of the positive terminal 712. In various embodiments, each torque driver may comprise a counterbore. For example, first torque driver 722 may comprise a counterbore proximate the negative terminal. The counterbore 723 may be threaded and/or configured to receive a stud therein.

Similarly, the electrical connector assembly 630 comprises third column 606, a negative terminal 742, a positive terminal 744, a first torque driver 752, a second torque driver 754, and a connector 770. The third column 606 may comprise a negative column 762, a positive column 764, and a non-conductive column 766. The non-conductive column 766 may be disposed between the positive column 764 and the negative column 762. The non-conductive column 766 may be configured to electrically isolate the positive column 764 from the negative column 762. Furthermore, connector 770 may comprise a non-conductive material and be configured to electrically isolate the positive terminal 744 from the negative terminal 742. The non-conductive material of the non-conductive column 766 and the connector 770 may comprise plastic, ceramic, or any other non-conductive material known in the art.

In various embodiments, each negative terminal (e.g., negative terminals 712, 742), may comprise a recess disposed on a mating surface. For example, negative terminal 742 may comprise a recess 741 disposed on mating surface 746. In various embodiments, each positive terminal (e.g., positive terminals 714, 744), may comprise a protrusion disposed on a mating surface. For example, positive terminal 744 may comprise a protrusion 745 disposed on mating surface 747. In various embodiments, the protrusion of a positive terminal may be configured to interface with a recess of a negative terminal. For example, the protrusion 745 of the positive terminal 744 may be configured to interface with a recess of a respective negative terminal for an adjacent interconnected battery module in an interconnected battery module system 10 as shown in FIG. 1.

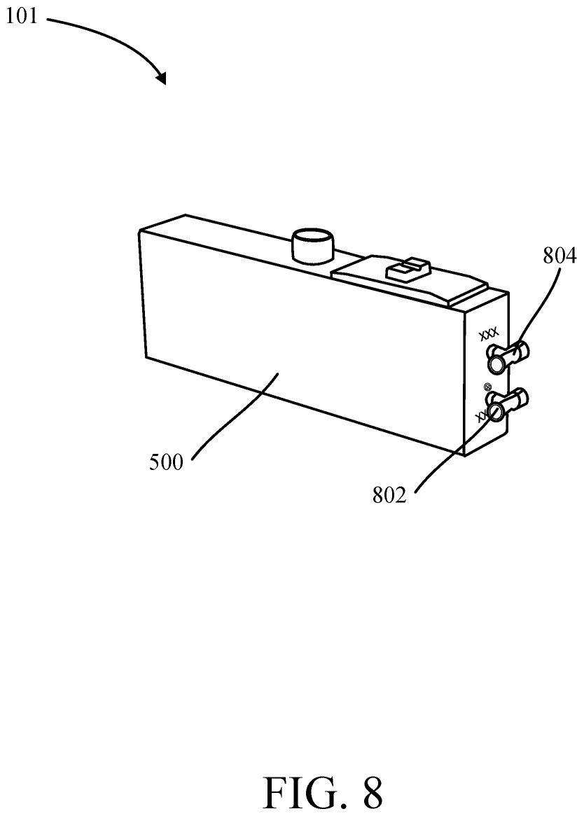

Referring now to FIG. 8, an interconnected battery module 101 for use in an interconnected battery module system 10 of FIG. 1, is illustrated, in accordance with various embodiments. In various embodiments, the interconnected battery module 101 comprises the enclosure 500, a first fluid port 802 and a second fluid port 804. First fluid port 802 may be coupled to, and in fluid communication with, a fluid inlet or a fluid outlet of a respective cold plate (e.g., cold plate 200) disposed within enclosure 500. Similarly, second fluid port 804 may be coupled to, and in fluid communication with, a fluid inlet or a fluid outlet of a respective cold plate (e.g., cold plate 200) disposed within enclosure 500. In various embodiments, fluid ports 802, 804 may be T-junction ports.

In various embodiments, each fluid port may be coupled to an adjacent fluid port of an adjacent interconnected battery module in an interconnected battery module system 10 from FIG. 1. In this regard, a cooling and/or heating system may be configured to flow a fluid through each cold plate in an interconnected battery module system 10 from FIG. 1 via the fluid ports 802, 804, the fluid inlet 240 and fluid outlet 250 of each cold plate 200, and a respective cooling channel for each cold plate. In this regard, cell temperatures within each interconnected battery module of an interconnected battery module 101 may be managed (i.e., control a temperature by varying the flow and/or temperature of a fluid flowing through the cold plate 200).

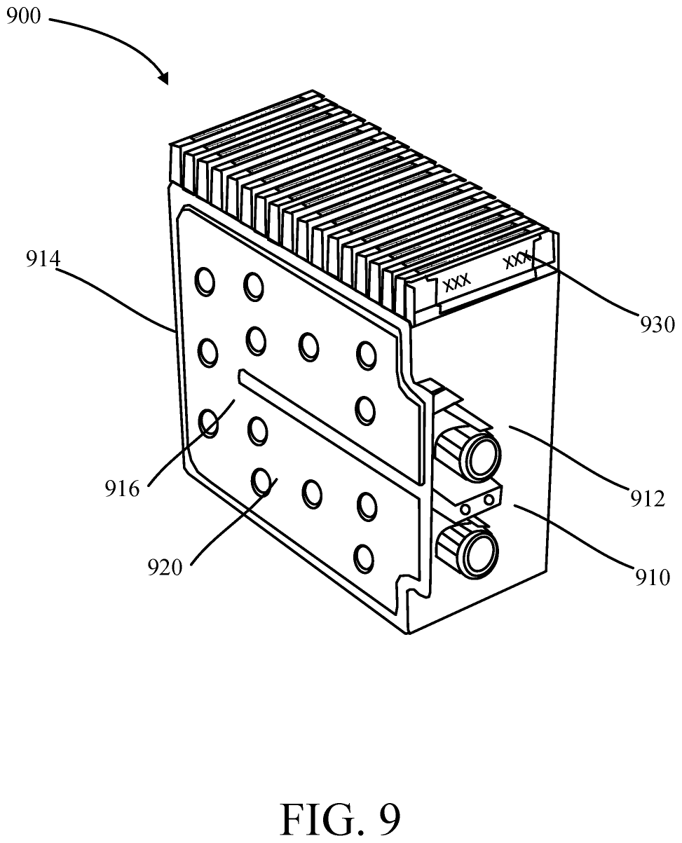

Referring now to FIG. 9, a portion of an interconnected battery module 900, in accordance with various embodiments, is illustrated. The interconnected battery module 900 may comprise a housing 910, a cold plate 920, and a plurality of pouch cells 930. The housing 910 may extend from a first end 912 to a second end 914. The housing 910 may be configured to house the plurality of pouch cells 930 therein. In various embodiments, the housing 910 and the cold plate 920 may be integral (e.g., a monolithic component). In various embodiments, the housing 910 and the cold plate 920 may be discrete components.

The cold plate 920 may be disposed at a first side 916 of housing 910. The cold plate 920 may comprise a fluid inlet 922 and a fluid outlet 924. The fluid inlet 922 may be in fluid communication with the fluid outlet 924 via a cooling channel disposed through the cold plate 920. The cooling channel may comprise a serpentine flow path similar to the cooling channel of cold plate 200 from FIG. 2. In this regard, fluid may travel in fluid inlet 922 at first end 912 of the housing 910 to second end 914 of the housing 910, back to first end 912 of the housing 910 and out fluid outlet 924. Each pouch may be coupled together electrically in series or in parallel. In various embodiments, each pouch in the plurality of pouch cells may be configured to be coupled to a busbar, such as busbar 410, 420, 430 from FIGS. 4A AND 4B.

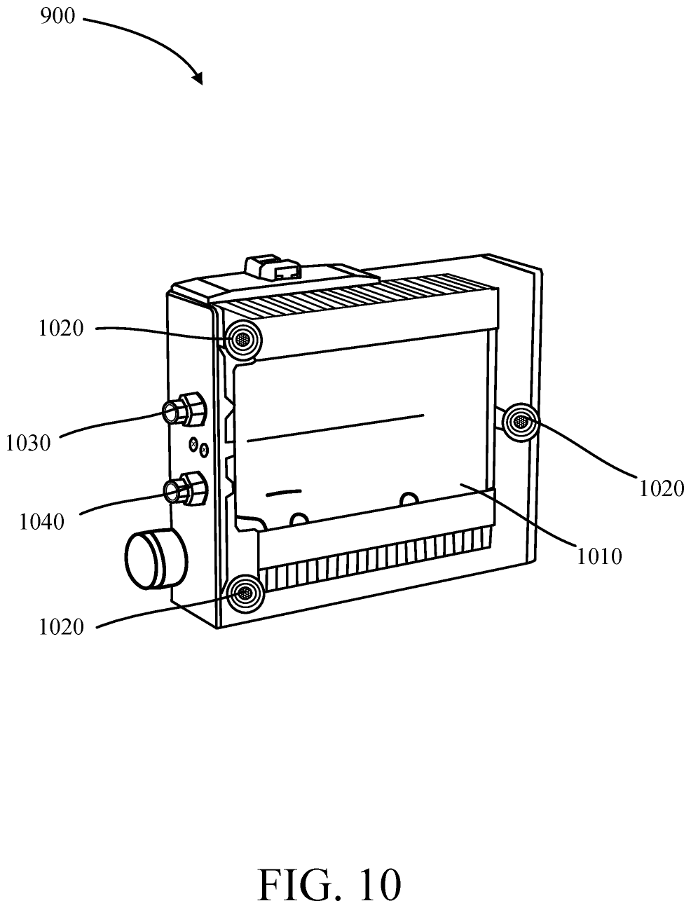

Referring now to FIG. 10, an interconnected battery module 900, in accordance with various embodiments, is illustrated. The interconnected battery module 900 may further comprise an enclosure 1010. The enclosure 1010 may be in accordance with enclosure 500 of FIG. 5 with the exception that enclosure 1010 is configured to receive the housing 910, the cold plate 920 and the plurality of pouch cells 930 from FIG. 9. The interconnected battery module 900 may further comprise a plurality of connector assemblies 1020. The plurality of connector assemblies may be in accordance with first connector assembly 610, second connector assembly 620, and/or electrical connector assembly 630 from FIGS. 6 and 7. In this regard, a plurality of the interconnected battery module 900 may be configured to form an interconnected battery module system, such as interconnected battery module system 10 from FIG. 1.

The interconnected battery module 900 may further comprise a first fluid port 1030 and a second fluid port 1040. The first fluid port 1030 may be in fluid communication with fluid inlet 922 and/or fluid outlet 924 of cold plate 920. Similarly, the second fluid port 1040 may be in fluid communication with fluid inlet 922 and/or fluid outlet 924 of cold plate 920.

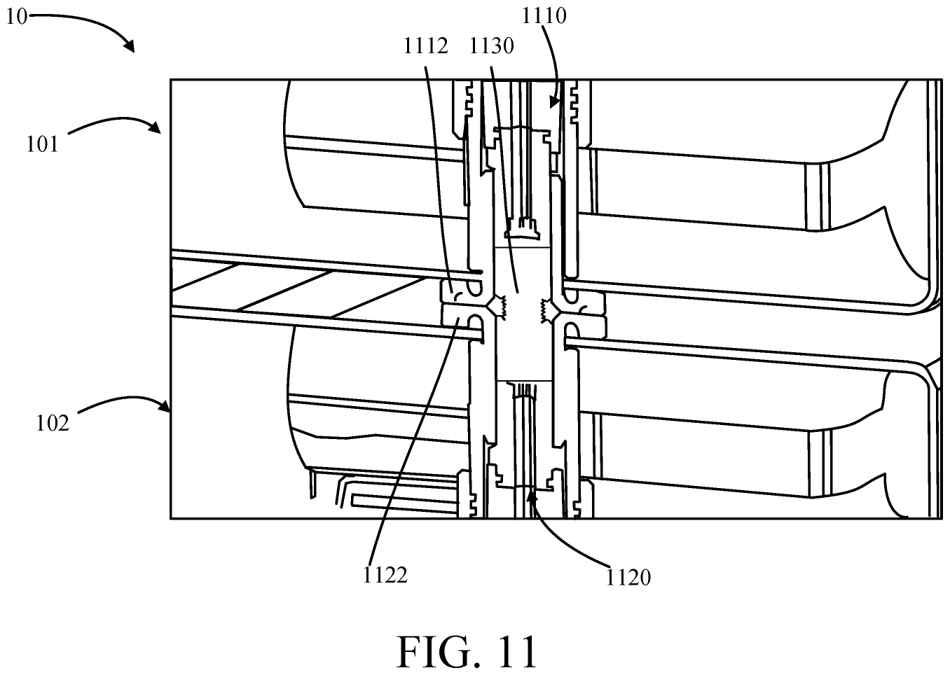

Referring now to FIG. 11, a cross-sectional view of a portion of an interconnected battery module system 10, in accordance with various embodiments, is illustrated. The interconnected battery module system 10 may comprise a first interconnected battery module 101 disposed adjacent to a second interconnected battery module 102. The first interconnected battery module 101 and the second interconnected battery module 102 are connected in series. In this regard, the first interconnected battery module 101 comprises a negative terminal 1112 of a first connector assembly 1110 and the second interconnected battery module 102 comprises a positive terminal 1122 of a second connector assembly 1120. The first connector assembly 1110 and the second connector assembly 1120 may be in accordance with connector assembly 630 from FIGS. 6 and 7.

In various embodiments, the interconnected battery module system 10, may further comprise a stud 1130 coupled to the first connector assembly 1110 and the second connector assembly 1120. The stud 1130 may engage a counterbore of the first connector assembly 1110 and the second connector assembly 1120 and form a threaded coupling. The counterbore may be in accordance with the counterbore 723 of first torque driver 722 from FIG. 7.

In various embodiments, with combined reference to FIGS. 7 and 11, the stud 1130 may be coupled to a counterbore of the first connector assembly 1110 of the first interconnected battery module 101 by torquing the stud in a respective counterbore of the connector assembly (e.g., counterbore 723). Next, the stud 1130 may be aligned with the second connector assembly 1120 of the second interconnected battery module 102. Next, an isolated tool, such as an Allen wrench, or a similar tool configured to drive torque into a respective torque driver, may be inserted from an opposite end of the connector assembly to drive a second torque driver (e.g., second torque driver 724 from FIG. 7). In this regard, the second torque driver may torque the second torque driver, the connector and the first torque driver (e.g., second torque driver 724, connector 730 and first torque driver 722) resulting in the stud 1130 also being torqued to engage the second connector assembly 1120 of the second interconnected battery module 102. As such, a first connector assembly 1110 may be coupled to second connector assembly 1120 of an adjacent interconnected battery module by torqueing a respective torque driver of either the first connector assembly 1110 or the second connector assembly 1120 from an opposite side of the mating interface.

In various embodiments, when the first interconnected battery module 101 is coupled to the second interconnected battery module 102, a respective protrusion of the positive terminal 1122 (e.g., protrusion 745 from FIG. 7) interfaces with a respective recess of negative terminal 1112 (e.g., recess 741 from FIG. 7) to create a series connection between first interconnected battery module 101 and second interconnected battery module 102.

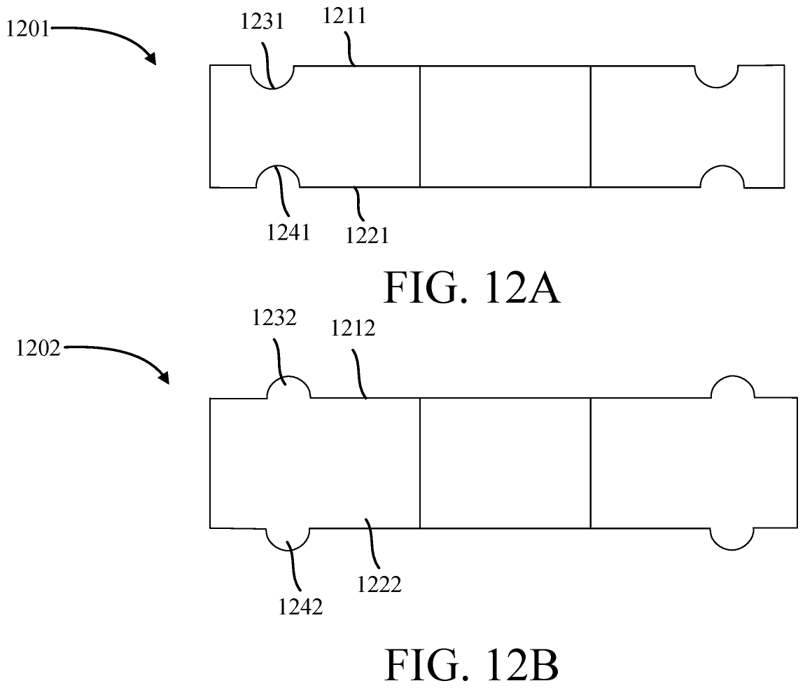

Referring now to FIGS. 12A and 12B, a first washer 1201 and a second washer 1202 each may be configured to facilitate a parallel connection between adjacent interconnected battery modules in an interconnected battery module system 10 from FIG. 1, are illustrated in accordance with various embodiments. In various embodiments, the first washer 1201 may comprise a first mating surface 1211 opposite a second mating surface 1221. The first mating surface 1211 may comprise a first recess 1231 extending circumferentially around the first mating surface 1211. Similarly, the second mating surface 1221 may comprise a second recess 1241 extending circumferentially around the second mating surface 1221. In this regard, the first mating surface 1211 and the second mating surface 1221 may both be configured to mate with a respective positive terminal (e.g., positive terminal 744 from FIG. 7). For example, a first positive terminal may be coupled to a second positive terminal by sandwiching a first washer 1201 between the first positive terminal and the second positive terminal. In this regard, the first washer 1201 may be inserted into an interconnected battery module system (e.g., interconnected battery module system 10 from FIG. 1) to change a series connection (e.g., positive terminal to negative terminal) to a parallel connection (e.g., positive terminal to positive terminal).

In various embodiments, the second washer 1202 may comprise a first mating surface 1212 opposite a second mating surface 1222. The first mating surface 1212 may comprise a first protrusion 1232 extending circumferentially around the first mating surface 1212. Similarly, the second mating surface 1222 may comprise a second protrusion 1242 extending circumferentially around the second mating surface 1222. In this regard, the first mating surface 1212 and the second mating surface 1222 may both be configured to mate with a respective negative terminal (e.g., positive terminal 744 from FIG. 7). For example, a first negative terminal may be coupled to a second negative terminal by sandwiching a second washer 1202 between the first negative terminal and the second negative terminal. In this regard, the first washer 1201 may be inserted into an interconnected battery module system (e.g., interconnected battery module system 10 from FIG. 1) to change a series connection (e.g., positive terminal to negative terminal) to a parallel connection (e.g., negative terminal to negative terminal).

In various embodiments, by coupling the interconnected battery module assemblies together, as described herein, may provide lateral strength to the interconnected battery module system 10 from FIG. 1.

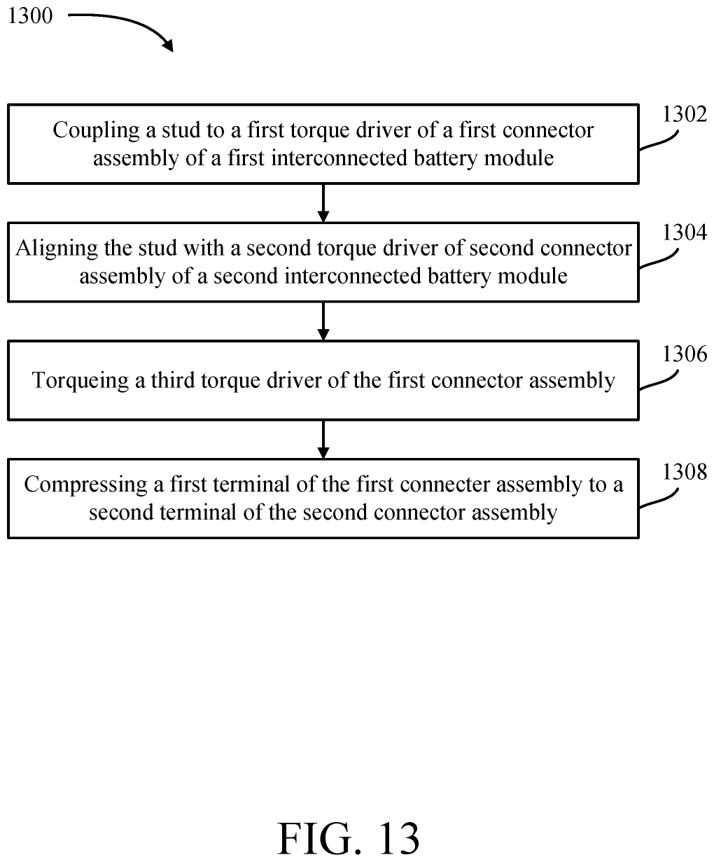

Referring now to FIG. 13, a method 1300 of coupling a first interconnected battery module to a second interconnected battery module is illustrated, in accordance with various embodiments. The method comprises coupling a stud to a first torque driver of a first connector assembly from a first interconnected battery module (step 1302). The stud may be coupled manually by torquing the stud into a counterbore of the first torque driver. In this regard, the stud may comprise a complimentary thread to a thread of the counterbore.

The method 1300 may further comprise aligning the stud with a second torque driver of a second connector assembly form a second interconnected battery module (step 1304). The stud may abut a counterbore of the second torque driver in response to aligning the stud with the second torque driver.

The method 1300 may further comprise torquing a third torque driver of the first connector assembly (step 1306). The third torque driver may be on a second side of the first interconnected battery module and the first torque driver may be on a first side of the interconnected battery module. The third torque driver may be operably coupled to the first torque driver. In this regard, in response to torquing the third torque driver, the first torque driver may also torque. In response to the torquing of the first torque driver, the stud may engage the second torque driver of the second interconnected battery module, coupling the first torque driver of the first interconnected battery module to the second torque driver of the second interconnected battery module.

The method 1300 may further comprise compressing the first terminal of the first connector assembly to a second terminal of the second connector assembly (step 1308). In this regard, the stud may be torqued into the counterbore of the second torque driver until a first terminal of the first connector assembly abuts a second terminal of the second connector assembly. The first terminal may be a positive terminal having a protrusion, and the second terminal may be a negative terminal having a recess, as disclosed herein.

In an example embodiment, an interconnected battery module as disclosed herein may comprise a nominal voltage of approximately 7 volts, a capacity of approximately 50 ampere-hours, an energy output of approximately 0.36 kWh, or the like. Although an example interconnected battery module may have these specifications, an interconnected battery module of any specification is within the scope of this disclosure. In an example embodiment, a 1,000 volt interconnected battery module system may be created by interconnecting 136 interconnected battery modules in series as disclosed herein. In various embodiments, by having each interconnected battery module isolated and discrete from the remaining interconnected battery modules, a thermal runaway event may be limited to a single interconnected battery module where the thermal runaway event occurs. In this regard, in accordance with various embodiments, an interconnected battery module, as disclosed herein, may be configured to contain a thermal runaway event of a cell disposed in the interconnected battery module without affecting any cell in any of the remaining interconnected battery modules.

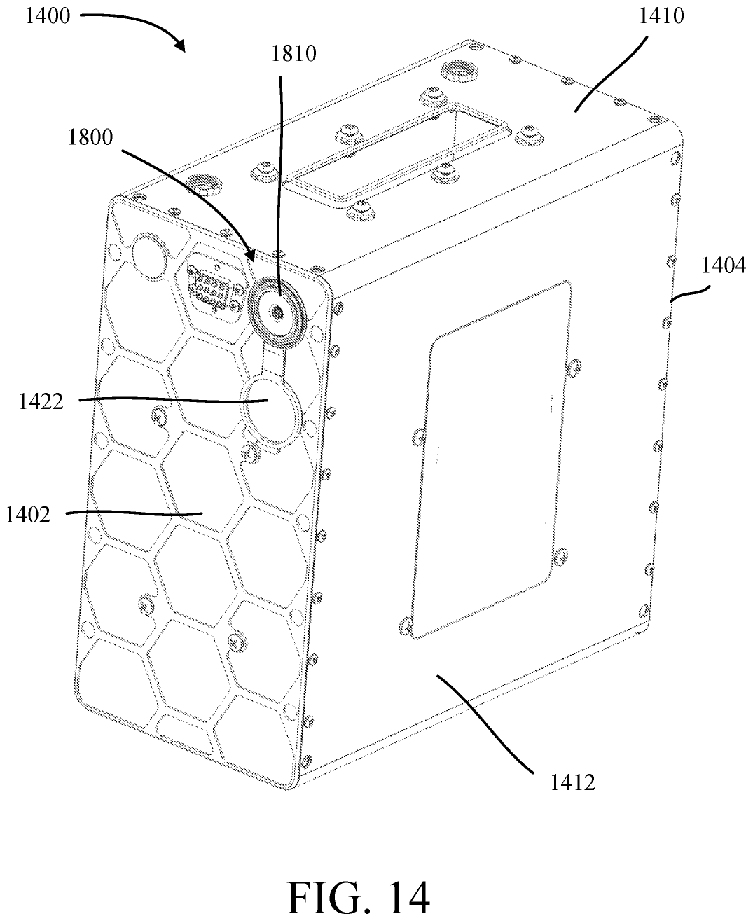

Referring now to FIG. 14, a perspective view of an interconnected battery module 1400 is illustrated, in accordance with various embodiments. The interconnected battery module 1400 comprises an enclosure assembly 1410. The enclosure assembly 1410 may comprise an outer enclosure 1412. The outer enclosure 1412 may include a composite, such as a cured polymer matrix composite (PMC) comprised of fiber composite and a resin matrix. The cured PMC may include thermoset polyimide resin mixture or a thermoset cyanate resin mixture having glass transition temperatures greater than 500 degree F. Although described as including a composite, the present disclosure is not limited in this regard. For example, the outer enclosure 1412 may be any suitable material, as recognized by one skilled in the art.

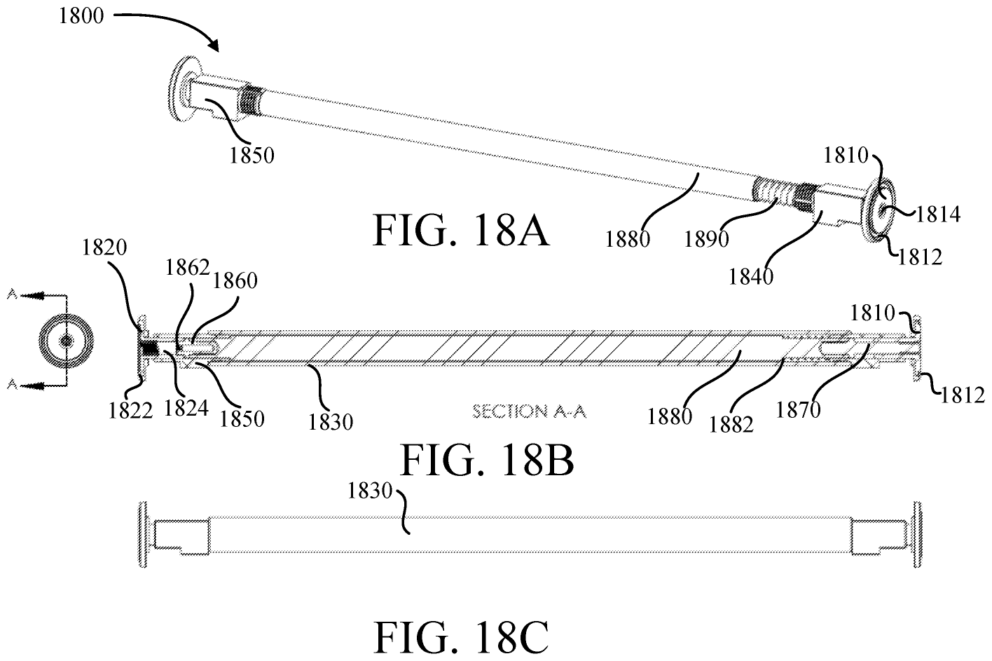

In various embodiments, the interconnected battery module 1400 further comprises an electrical connector assembly 1800. The connector assembly is in accordance with the electrical assembly 630 from FIG. 6, except as otherwise described herein. In various embodiments, a plug 1422 may be removable coupled to a first electrical terminal 1810 (e.g., positive terminal or negative terminal) disposed on a first side 1402 of the outer enclosure 1412 (i.e., the plug 1422 may be configured to protect the first terminal while the interconnected battery module 1400 is not in use). A second terminal (e.g., an opposite terminal of first electrical terminal 1810) is disposed on a second side 1404 of the outer enclosure 1412, the second side 1404 being opposite the first side 1402. In various embodiments, the second electrical terminal 1820 (see FIG. 18B) may have a plug in accordance with plug 1422 disposed therein.

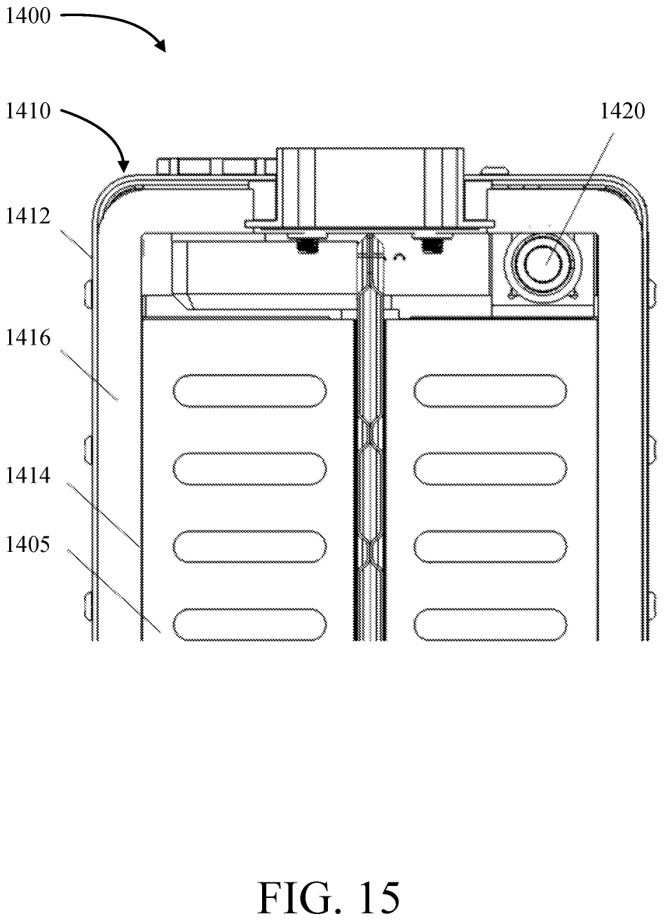

Referring now to FIG. 15, a cross-sectional view of the interconnected battery module 1400 is illustrated, in accordance with various embodiments. In various embodiments, the enclosure assembly 1410 further comprises an inner enclosure 1414. In various embodiments, the inner enclosure 1414 is spaced apart, at least partially, from the outer enclosure 1412. In various embodiments, the enclosure assembly further comprises an insulation material 1416 disposed between the inner enclosure 1414 and the outer enclosure 1412. Although illustrated as having an insulation material 1416 between the inner enclosure 1414 and the outer enclosure 1412, the present disclosure is not limited in this regard. For example, an air gap may be defined between the inner enclosure 1414 and the outer enclosure 1412 in accordance with various embodiments. In various embodiments, by having the outer enclosure 1412 spaced apart from the inner enclosure 1414, heat generated from a thermal runaway event within the inner enclosure 1414 may be contained and/or a temperature of the outer enclosure 1412 during the thermal runaway event may be significantly reduced relative to a battery module with only a single enclosure.

The enclosure assembly 1410 of the interconnected battery module 1400, in totality, may further facilitate thermal isolation from adjacent interconnected battery modules, in accordance with various embodiments. For example, as illustrated in FIG. 1, interconnected battery modules may be disposed in close proximity to adjacent interconnected battery modules, and by having a high glass transition temperature material as the outer enclosure 1412, an inner enclosure 1414, and an insulation material 1416 (or an air gap) disposed therebetween, heat from a thermal runaway event may be mostly retained within the respective enclosure assembly 1410 preventing propagation to adjacent interconnected battery modules, in accordance with various embodiments. In various embodiments, the inner enclosure 1414 may comprise a typical battery module enclosure material (e.g., aluminum or stainless steel type liner).

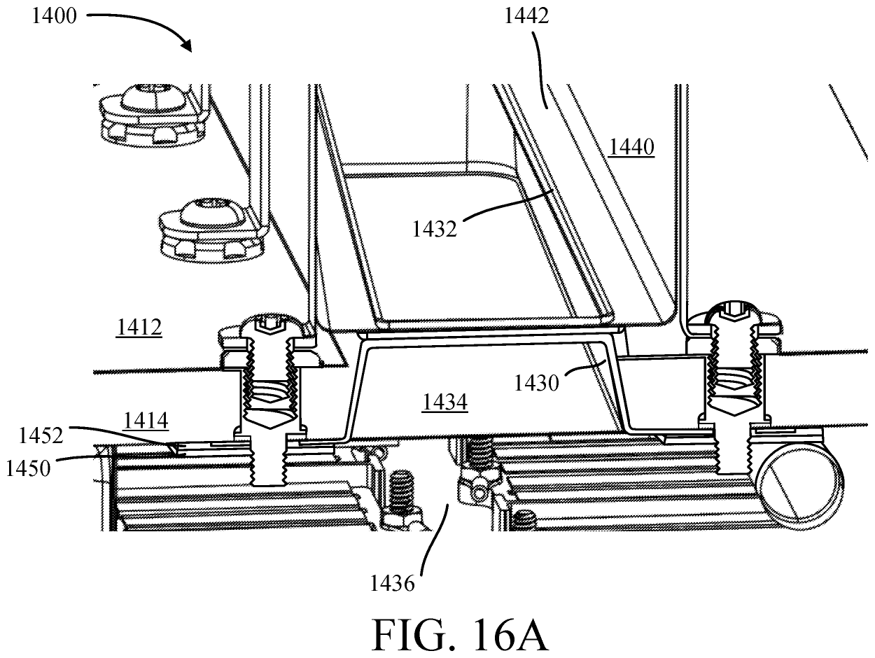

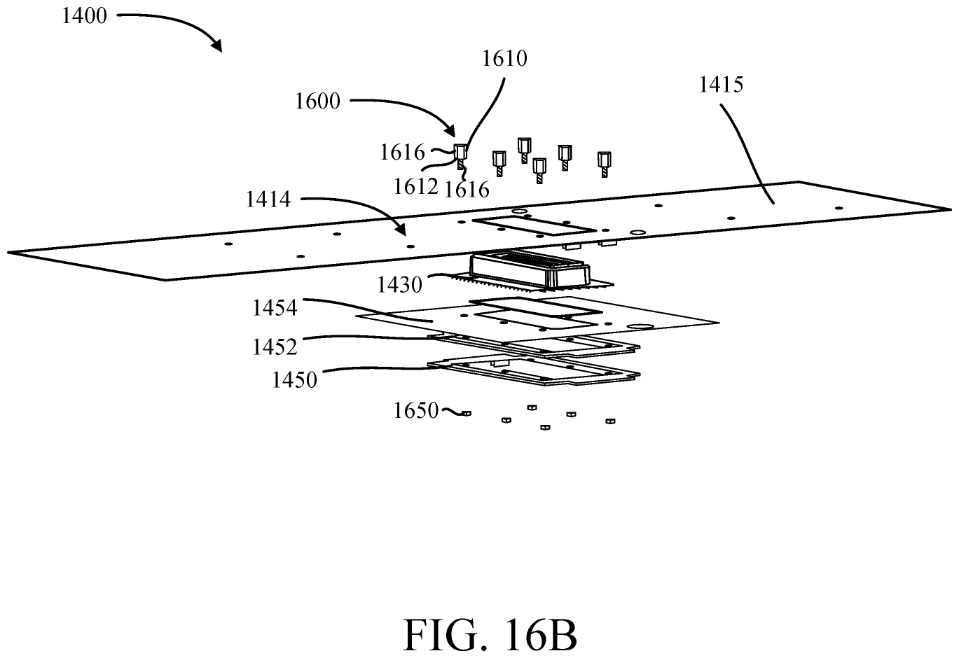

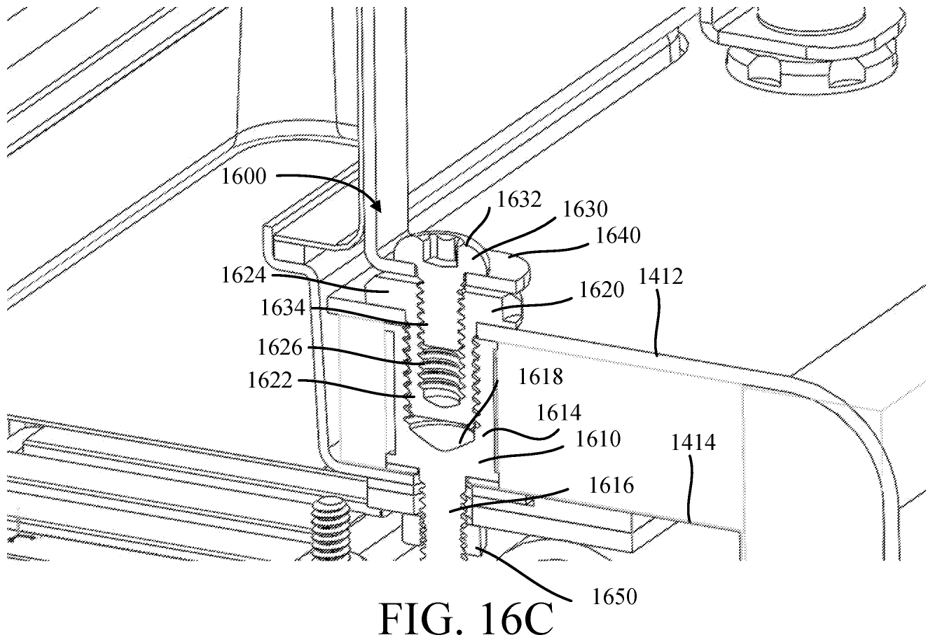

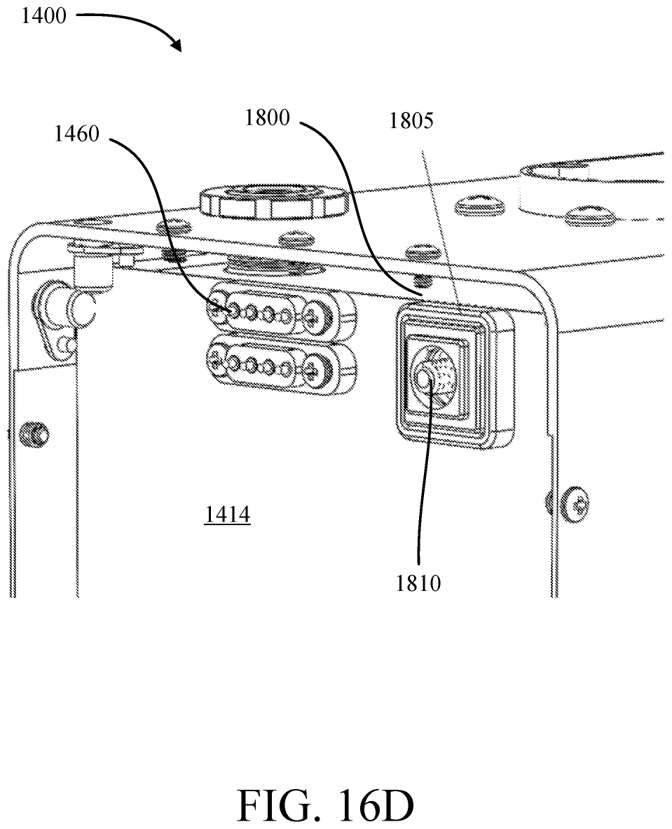

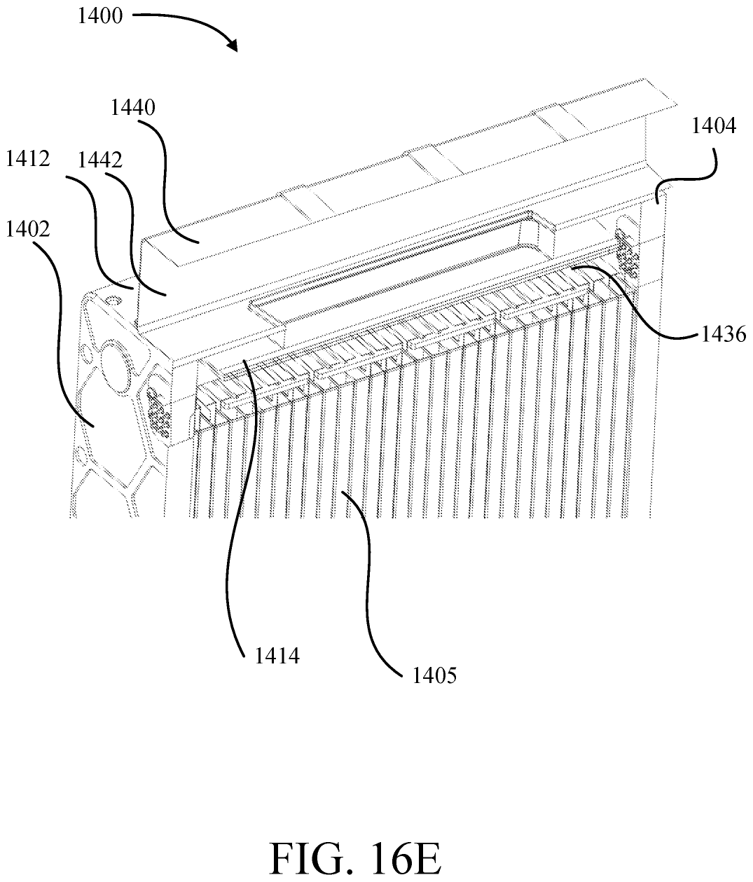

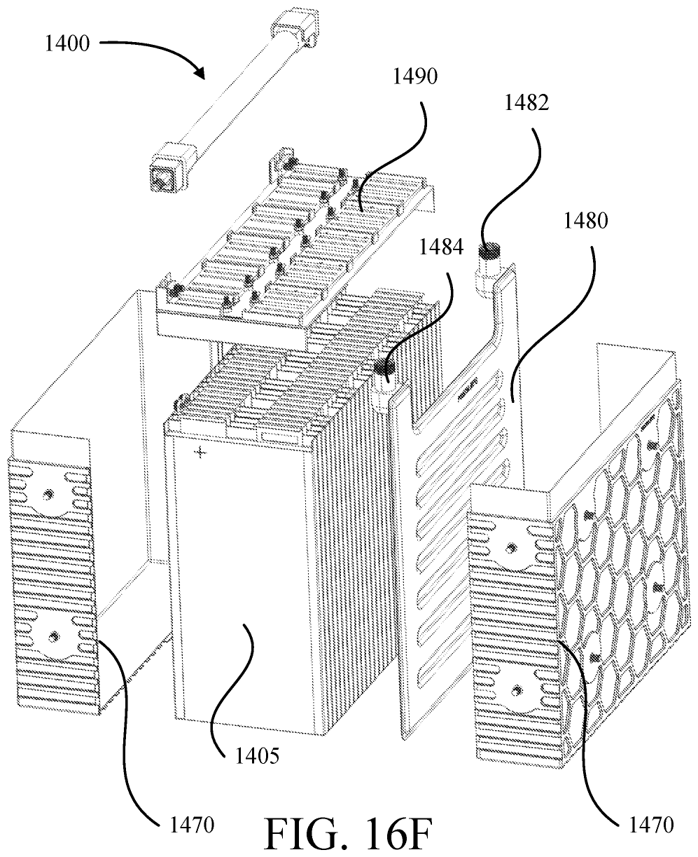

Referring now to FIG. 16A, a perspective cross-sectional view of the interconnected battery module 1400 is illustrated, in accordance with various embodiments. In various embodiments, the interconnected battery module 1400 further comprises a vent 1430 coupled to the inner enclosure 1414. In various embodiments, the vent 1430 may be coupled to the inner enclosure 1414 and/or the outer enclosure 1412. Although illustrated as being a separate component, the vent 1430 may be integral with the inner enclosure 1414 or the outer enclosure 1412, in accordance with various embodiments. The vent 1430 comprises a vent port 1432.

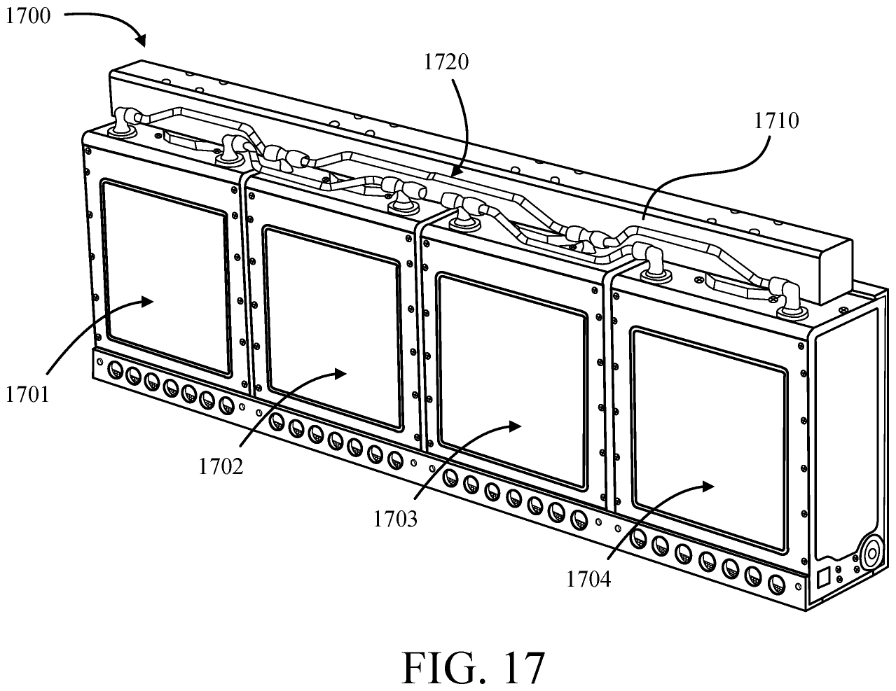

In various embodiments, the interconnected battery module 1400 comprises a gang vent portion 1440. The gang vent portion 1440 may be a portion of a gang vent (e.g., common vent port 1710 from FIG. 17 as described further herein) of a battery system (e.g., battery system 1700 from FIG. 17). In various embodiments, the gang vent portion 1440 is a component of a plurality of gang vent portions, which form a gang vent for all of the interconnected battery modules in a sting of interconnected battery modules. In this regard, a plurality of the gang vent portion 1440 define a common exhaust path for a plurality of the interconnected battery module 1400 of a battery system (e.g., battery system 1700 from FIG. 17).

In various embodiments, the interconnected battery module 1400 comprises a breathable vent 1434 disposed at an inlet of the vent 1432. The breathable vent 1434 is configured to pass air and/or prevent moisture from passing during normal operation. In various embodiments, the breathable vent 1434 is configured to rupture due to pressure from a thermal runaway event of a cell in the plurality of cells of the interconnected battery module 1400. In this regard, ejecta and/or gases from the thermal runaway event may efficiently escape during the thermal runaway event and be exhausted out the gang vent as described previously herein.

In various embodiments, the interconnected battery module 1400 comprises a printed circuit board 1450 disposed proximate an internal surface of the inner enclosure 1414. The printed circuit board 1450 may include an aperture disposed therethrough having a similar shape to an inlet of the vent 1430. The aperture of the printed circuit board 1450 may allow gases and/or ejecta be exhausted therethrough during a thermal runaway event within internal cavity 1436. In various embodiments, the printed circuit board 1450 may be configured to be a local controller for the interconnected battery module 1400.

In various embodiments, an electrical isolation layer 1452 is disposed between the printed circuit board 1450 and the inner enclosure 1414. The electrical isolation layer may have a similar shape as the printed circuit board 1450. In various embodiments, the electrical isolation layer 1452 may be thermally conductive to provide a path for heat from the printed circuit board 1450 to escape during normal operation of the interconnected battery module 1400.

Referring now to FIG. 16B, an exploded view of a portion of the interconnected battery module 1400 from FIGS. 14-16F is illustrated during assembly/manufacturing, in accordance with various embodiments. In various embodiments, the interconnected battery module 1400 further comprises a sacrificial thermal layer 1454 disposed between the breathable vent 1434 and the electrical isolation layer 1452. In various embodiments, the sacrificial thermal layer 1454 may be a metal sheet, such as a stainless steel metal sheet, a nickel alloy metal sheet, or the like. In various embodiments, the sacrificial thermal layer is configured to protect the inner enclosure 1414 from FIGS. 14-16A from ejecta and/or other debris in a thermal runaway event. In various embodiments, the inner enclosure 1414 comprises a sheet 1415. The sheet 1415 may be a flat sheet prior to assembly/manufacturing. During assembly, the 1415 may be bent on a first side and bent on a second side to form a first side of the inner enclosure 1414, a second side of the inner enclosure 1414 and a top side of the inner enclosure 1414. Then, a similar process may be performed for second sheet defining a bottom side, a front side and a back side of the inner enclosure 1414. Then, the edges may be joined by any joining method, such as brazing, welding, soldering, or the like to create the inner enclosure 1414.

In various embodiments, a stack-up of the printed circuit board 1450, the electrical isolation layer 1452, the sacrificial thermal layer 1454, a top side of the inner enclosure 1414 is clamped between a mating surface 1612 of a first fastener 1610 from a fastener assembly 1600 and a mating surface of a nut 1650. For example, the first fastener 1610 may comprise a spacer portion 1614 defining the mating surface 1612 and a shaft 1616 extending away from the mating surface 1612. In various embodiments, the shaft 1616 is a threaded shaft having male threads and the nut is a threaded nut having female threads. Thus, the shaft 1616 is configured to engage the nut 1650 and clamp the stack-up together, in accordance with various embodiments. In various embodiments, a flange of the vent 1430 may be disposed between the sacrificial thermal layer 1454 and the top side of the inner enclosure 1414 without having an aperture for the shaft 1616 to go through. In various embodiments, the flange of the vent 1430 may be extended and include an aperture for the shaft 1616 to go through. The present disclosure is not limited in this regard.

Referring now to FIG. 16C, a cross-sectional view of the fastener assembly 1600 after assembly of the interconnected battery module 1400 is illustrated, in accordance with various embodiments. In various embodiments, the fastener assembly 1600 comprises a first fastener 1610, a second fastener 1620, a third fastener 1630, and the nut 1650. Although illustrated as having a nut 1650, the printed circuit board 1450 could include a threaded portion configured to engage the shaft 1616 of the first fastener 1610, in accordance with various embodiments.

In various embodiments, in an assembled state, the spacer portion 1614 of the first fastener 1610 extends from an outer surface of the top side of the inner enclosure 1414 to an inner surface of a top side of the outer enclosure 1412. In various embodiments, the spacer portion 1614 of the fastener assembly 1600 facilitates a spacing between the inner enclosure 1414 and the outer enclosure 1412. In this regard, the spacer portion 1614 is configured to prevent propagation of a thermal runaway event to an adjacent interconnected battery module, in accordance with various embodiments. Thus, the spacing provided by spacer portion 1614 of the first fastener 1610 may reduce a temperature experienced by the outer enclosure 1412 during a thermal runaway event within the inner enclosure 1414 relative to an interconnected battery module 1400 that does not have the inner enclosure 1414 and the outer enclosure 1412 spaced apart.

In various embodiments, the first fastener includes an aperture 1618 disposed therein. In various embodiments the aperture 1618 may be a through-hole or a blind hole. In various embodiments, the aperture 1618 is a blind hole. In this regard, the aperture 1618 may include a greater diameter relative to a diameter of the shaft 1616. In this regard, the second fastener 1620 engaging the aperture 1618 of the first fastener 1610 may be configured to carry more of a structural load relative to the shaft 1616 of the first fastener 1610 engaging the nut 1650. In various embodiments, the aperture 1618 includes a threaded portion. In various embodiments, an insert, such as a helical insert or the like, may be disposed in the aperture 1618 to facilitate engagement with a shaft 1622 of the second fastener 1620. For example, the second fastener 1620 comprises a shaft 1622 extending away from a head 1624 into the aperture 1618 of the first fastener 1610. The shaft 1622 may comprise a threaded shaft, or the like.

In various embodiments, the second fastener 1620 comprises an aperture 1626 disposed in a surface of head 1624 towards and into the shaft 1622. In various embodiments, the aperture 1626 has a diameter that is less than a diameter of the shaft 1622. In this regard, the aperture 1626 may be a through-hole or a blind hole. The aperture 1626 may be in accordance with aperture 1618 as described above.

In various embodiments, the fastener assembly 1600 further comprises a third fastener 1630 configured to couple to the second fastener 1620. The third fastener 1630 comprises a head 1632 and a shaft 1634. In various embodiments, the shaft 1634 is a threaded shaft configured to engage the aperture 1626 of the first fastener. In various embodiments, a bracket 1640 configured to support the gang vent portion 1440 is disposed between a mating surface of the head 1632 of the third fastener and a mating surface of the head 1624 of the second fastener. Thus, the fastener assembly 1600 may be a multi-faceted assembly configured to provide support for various components and enhance thermal management for the interconnected battery module 1400, in accordance with various embodiments. In various embodiments, centerlines of shaft 1616, aperture 1618, shaft 1622, aperture 1626, and shaft 1634 may be co-axial.

Referring now to FIG. 16D, a portion of the interconnected battery module 1400 is illustrated, in accordance with various embodiments. In various embodiments, the electrical connector assembly 1800 may further comprise an isolator cover 1805. In various embodiments, the isolator cover 1805 may electrically isolate the first electrical terminal 1810 from the inner enclosure 1414. In particular, the isolator cover is configured to protect the electrical connector assembly 1800 from a short circuit on the inner enclosure 1414 and/or to seal the inner enclosure from leaks during a thermal runaway event, in accordance with various embodiments. In various embodiments, the interconnected battery module 1400 further comprises a communications interface 1460. In this regard, the communications interface 1460 may be configured to couple to an adjacent communications interface, in accordance with various embodiments.

Referring now to FIG. 16E a cross-sectional view of a portion of the interconnected battery module 1400 along an axis parallel to a perpendicular direct to first side 1402 is illustrated, in accordance with various embodiments. In various embodiments, the interconnected battery module 1400 includes a plurality of cells 1405 disposed within internal cavity 1436 of inner enclosure 1414. In various embodiments, each cell in the plurality of cells 1405 is a pouch cell. Although illustrated as having pouch cells the present disclosure is not limited in this regard, and the systems and assemblies described herein can easily apply to prismatic cells, cylindrical cells, or the like.

In various embodiments, the gang vent portion 1440 extends from the first side 1402 to the second side 1404 along a top side of outer enclosure 1412. In various embodiments, a centerline of the conduit 1442 defined by the gang vent portion 1440 defines an axial direction of the interconnected battery module 1400. Although illustrated as comprising a rectangular cross-section, the gang vent portion 1440 is not limited in this regard. For example, a circular or oval cross-section for the gang vent portion 1440 is within the scope of this disclosure.

In various embodiments, a plurality of the bracket 1640 may structurally support gang vent portion 1440. For example, by coupling the bracket 1640 to the outer enclosure 1412 on opposite sides of the gang vent portion 1440, the gang vent portion 1440 may be clamped to the outer enclosure 1412.

Referring now to FIG. 16F, an exploded view of a portion of the interconnected battery module 1400 is illustrated in accordance with various embodiments. In various embodiments, the interconnected battery module 1400 further comprises a cell housing 1470 and a cold plate 1480. The cell housing 1470 may comprise a first half and a second half for assembly purposes. In various embodiments, the cell housing 1470 may comprise studs for coupling to the outer enclosure 1412 from FIG. 14. In various embodiments, the studs may extend through apertures in the inner enclosure 1414 from FIG. 14.

In various embodiments, the interconnected battery module 1400 comprises a cold plate 1480. Similar to the cold plate 200 from FIG. 2, the cold plate 1480 may act as a structural support for the plurality of cells 1405, in accordance with various embodiments. The cold plate 1480 comprises an inlet port 1482 and an outlet port 1484, in accordance with various embodiments. The cold plate 1480 may be disposed between a side of the plurality of cells 1405 and a side of the cell housing 1470, in accordance with various embodiments. In various embodiments, the cold plate 1480 is disposed only on single side of the plurality of cells 1405. Although illustrated in this manner, the present disclosure is not limited in this regard.

Referring now to FIG. 17, an interconnected battery system 1700 is illustrated, in accordance with various embodiments. In various embodiments, the interconnected battery system 1700 includes a plurality of interconnected battery modules (e.g., interconnected battery modules 1701, 1702, 1703, 1704). Each battery module in the plurality of interconnected battery modules may be in accordance with any of the interconnected battery modules disclosed previously herein. In various embodiments, each vent port for a respective interconnected battery module may be fluidly coupled to a common vent port 1710 for the interconnected battery system 1700. In this regard, weight and cost of the interconnected battery system 1700 may be reduced by having a vent routing that is common between all interconnected battery modules.

In various embodiments, the interconnected battery system 1700 includes a cooling system 1720. The cooling system 1720 may utilize the inlet and outlet ports of the cold plates of the interconnected battery modules as described previously herein. In various embodiments, each inlet port of an interconnected battery module may be fluidly coupled to an adjacent inlet port of an interconnected battery module, thus fluidly coupling the inlet ports in series, followed by the outlet ports in series. The orientation of the coolant flow path for the cooling system 1720 is not limited in the present disclosure. One skilled in the art may realize various different orientations for orienting cooling flow. For example, in various embodiments, an outlet port of a first interconnected battery module may be coupled to an inlet port of an adjacent interconnected battery modules as well. In this regard, coolant may serpentine through interconnected battery modules, in accordance with various embodiments.

In various embodiments, by utilizing a high temperature resistant composite for the enclosure, as disclosed herein, a thermal runaway event may be contained within an interconnected battery module without propagating the thermal runaway event to any adjacent interconnected battery modules of a respective interconnected battery module system.

Referring now to FIGS. 18A-C, a perspective view of a electrical connector assembly 1800 (FIG. 18A), a cross-sectional view of electrical connector assembly 1800 (FIG. 18B), and a side view of electrical connector assembly 1800 (FIG. 18C) are illustrated, in accordance with various embodiments. The electrical connector assembly 1800 is an electrical connector assembly in accordance with connector assemblies 630, 1120, except as described herein. The electrical connector assembly 1800 comprises a first electrical terminal 1810 disposed at a first end of the electrical connector assembly 1800, a second electrical terminal 1820 disposed at a second end of the electrical connector assembly 1800 and a housing 1830 disposed between the first electrical terminal 1810 and the second electrical terminal 1820. In various embodiments, one of the first electrical terminal 1810 and the second electrical terminal 1820 is a positive electrical terminal for the interconnected battery module 1400 from FIGS. 14-16F, and the other electrical terminal is a negative electrical terminal. In this regard, the first electrical terminal 1810 and the second electrical terminal 1820 are electrically isolated through the electrical connector assembly 1800 and electrically coupled through a plurality of cells within the interconnected battery module 1400 as described further herein. In various embodiments, the electrical connector assembly 1800 is configured to facilitate an electrical coupling between adjacent interconnected battery modules (e.g., interconnected battery modules 1701, 1702 from FIG. 17) without the use of wires or wiring harnesses. In this regard, electrical connector assembly 1800 facilitates hard electrical couplings between adjacent battery modules essentially eliminating wiring/wiring harnesses in a battery system, in accordance with various embodiments.

In various embodiments, the first electrical terminal 1810 is similar in shape and function with negative terminal 712 of electrical connector assembly 630 from FIG. 7. In this regard, first electrical terminal 1810 includes a recess 1812. The recess 1812 may define a groove disposed radially outward from an aperture 1814 disposed axially through the first electrical terminal 1810.

Similarly, in various embodiments, the second electrical terminal 1820 similar in shape and function with positive terminal 714 from FIG. 7. In this regard, the second electrical terminal 1820 includes a protrusion 1822. The protrusion 1822 may be annular in shape and/or disposed radially outward from an aperture 1824 disposed axially through the second electrical terminal 1820.

In various embodiments, a first conductive column 1840 is coupled to the first electrical terminal 1810. The first conductive column 1840 may be configured to couple to a busbar in electrical communication with a negative terminal of a cell in a plurality of cells in the interconnected battery module 1400 of FIGS. 14-16F, in accordance with various embodiments.

In various embodiments, a second conductive column 1850 is coupled to the second electrical terminal 1820. The second conductive column 1850 may be configured to couple to a busbar in electrical communication with a positive terminal of a cell in a plurality of cells in the interconnected battery module 1400 of FIGS. 14-16F. As described previously, and further herein, the plurality of cells in interconnected battery module 1400 may be electrically coupled together view a conductive strip, or the like. In this regard, an electrical path may be created for the interconnected battery module 1400 from FIGS. 14-16F from the first electrical terminal 1810 through the first conductive column 1840, through the plurality of cells, through the second conductive column 1850, and through the second electrical terminal as described previously and further herein.

In various embodiments, the housing 1830 is coupled to, and extends from, the first conductive column 1840 to the second conductive column 1850. In various embodiments, the housing 830 is made of a non-conductive material may comprise plastic, ceramic, or any other non-conductive material known in the art. The housing 830 may electrically isolate the first electrical terminal 1810 from the second electrical terminal 1820 through the electrical connector assembly 1800 as described previously herein.

In various embodiments, the electrical connector assembly 1800 further comprises a torque driver 1860 disposed proximate the second electrical terminal 1820 and operably coupled to a stud 1870 disposed proximate the first electrical terminal 1810 via a shaft 1880. The torque driver 1860 comprises a tool interface 1862. A “tool interface” as defined herein, is any interface configured to interact with a tool to generate torque in the torque driver about an axis defined by an axial centerline through the torque driver 1860, the shaft 1880 and the stud 1870. For example, a tool may comprise an Allen wrench, a screwdriver, or the like. In various embodiments, in response to a tool torquing the torque driver 1860, the shaft 1880 rotates and translates the torque driver 1860, the shaft 1880 and the stud axially away from the second electrical terminal 1820 towards the first electrical terminal 1810 and causing the stud 1870 to protrude out of the aperture 1814 of the first electrical terminal and away from a mating surface of the first electrical terminal.

In various embodiments, the stud 1870 comprises a male threaded stud and the aperture 1824 of the second electrical terminal comprises a female threaded surface configured to engage the male threaded stud. In various embodiments, the female threaded surface may be a separate component (e.g., a helical insert or the like), or integral with the second electrical terminal 1820. In this regard, a first electrical terminal 1810 of a first interconnected battery module (e.g., interconnected battery module 1400 from FIGS. 14-16F) may be electrically coupled to a second electrical terminal 1820 of a second interconnected battery module by torquing torque driver 1860 from the first interconnected battery module, engaging a stud 1870 of the first interconnected battery module with an aperture 1824 of the second electrical terminal 1820 from the second interconnected battery module until recess 1812 of first electrical terminal 1810 from the first interconnected battery module is in contact with protrusion 1822 of second electrical terminal 1820 from the second interconnected battery module. Thus, the electrical connector assembly 1800 facilitates a stackable, hard, electrical coupling between adjacent interconnected battery modules, in accordance with various embodiments.

In various embodiments, the electrical connector assembly 1800 is spring loaded. For example, a spring 1890 may extend from an axial end of the stud 1870 toward a should 1882 of shaft 1880. In this regard, the spring 1890 may be compressed in response to rotation of shaft 1880 and create a pulling force at a respective electrical interface between adjacent interconnected battery modules, in accordance with various embodiments.

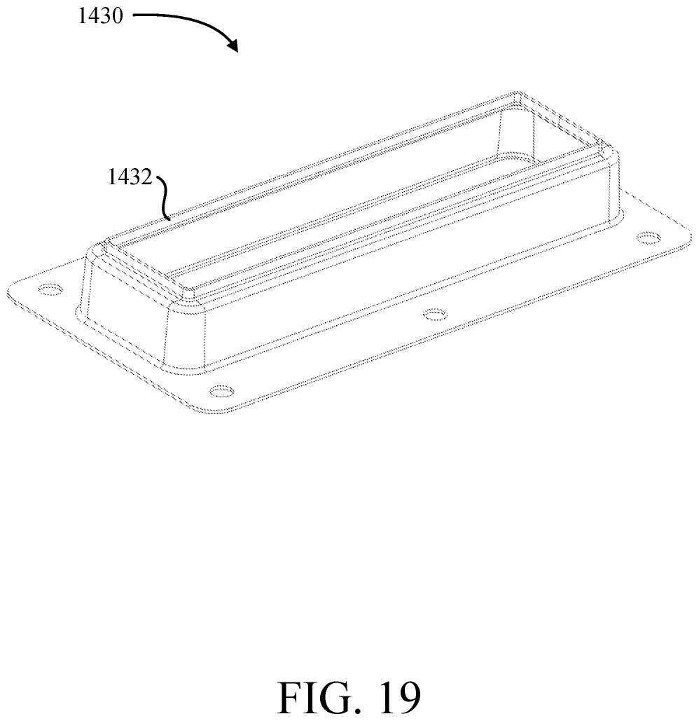

Referring now to FIG. 19, a perspective view of the vent 1430 is illustrated, in accordance with various embodiments. In various embodiments, the vent 1430 has an aspect ratio that is 2:1 or greater. In various embodiments, the aspect ratio is between 2:1 and 10:1, or between 2:1 and 6:1, or approximately 4:1. In accordance with various embodiment the aspect ratio is relative to the aspect ratio of a top side of the outer enclosure 1412 of the interconnected battery module from FIGS. 14-16F. In accordance with various embodiments, the aspect ratio of the vent port is defined by vent port 1432 through which smoke and ejecta would flow in the event of a thermal runaway event within internal cavity 1436 of the inner enclosure 1414 of interconnected battery module 1400 from FIGS. 14-16F. In various embodiments, the aspect ratio is configured to reduce the chance of large debris from a thermal runaway event blocking the vent port 1432 and/or preventing flow of the smoke and ejecta. It is noted that the aspect ratio of the vent port is somewhat dictated by the exhaust duct (e.g., gang vent portion 1440 of interconnected battery module 1400 from FIGS. 14-16F). In various embodiments, the exhaust duct is a common header (i.e., a gang vent comprising a plurality of the gang vent portion 1440) running in the X direction, and the aspect ratio of the vent 1430 is oriented such that the long direction of the vent 1430 runs in the same direction as the exhaust duct common header. Thus, a large opening in each interconnected battery module (e.g., interconnected battery modules 1701, 1702, 1703, 1704 from FIG. 17), of a plurality of modules does not result in a large exhaust duct. Rather the common header can receive the narrow/wide vent but be of a reasonable size. Additionally, since typically only a single vent (e.g., vent 1430) would be venting ejecta and/or hot gases from a thermal runaway event, the gang vent comprising the gang vent portion 1440 of the interconnected battery module 1400 from FIGS. 14-16F may be sized based on a single interconnected battery module 1400.

In various embodiments, the interconnected battery module 1400 further comprises a busbar 1490 configured to electrically couple the plurality of cells 1405 in parallel or series. In various embodiments, the plurality of cells 1405 are electrically coupled in parallel. In various embodiments, the plurality of cells 1405 may be electrically coupled together by any method, such as soldering, welding, or the like.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

We claim:

1. An interconnected battery module, comprising:
a first enclosure;
a second enclosure disposed within the first enclosure; and
a plurality of cells disposed within the second enclosure, the interconnected battery module configured to be coupled electrically and mechanically to an adjacent interconnected battery module, the adjacent interconnected battery module in accordance with the interconnected battery module.

2. The interconnected battery module of claim 1, further comprising a vent coupled to the first enclosure and the second enclosure, the vent in fluid communication with a cavity defined by the second enclosure.

3. The interconnected battery module of claim 2, further comprising a gang vent portion coupled to the second enclosure, the gang vent portion in fluid communication with the cavity via the vent, wherein:
a first direction is defined by a perpendicular direction from a first side, the first side configured to interface with the adjacent interconnected battery module,
the gang vent portion comprising an axial direction that is parallel to the first direction,
the vent having an aspect ratio greater than 2:1 in the first direction.

4. The interconnected battery module of claim 3, wherein:
the gang vent portion is configured to couple to an adjacent gang vent portion of the adjacent interconnected battery module to form a portion of a gang vent for a battery system, and
the gang vent portion is clamped to the first enclosure.

5. The interconnected battery module of claim 1, further comprising a fastener assembly, the fastener assembly comprising a first fastener and a second fastener, the first fastener including a spacer portion, the spacer portion disposed between the first enclosure and the second enclosure.

6. The interconnected battery module of claim 5, wherein the first fastener further comprises a first shaft extending from the spacer portion into a cavity defined at least partially by the second enclosure.

7. The interconnected battery module of claim 6, wherein the first fastener includes a first aperture extending axially into the spacer portion, the first aperture being co-axial with the first shaft.

8. The interconnected battery module of claim 7, wherein the second fastener comprises a first head and a second shaft extending from the first head, the second shaft configured to engage the first aperture to couple the second fastener to the first fastener.

9. The interconnected battery module of claim 8, wherein:
the fastener assembly further comprises a third fastener, the third fastener including a second head a third shaft,
the second fastener comprising a second aperture disposed axially therein,
the second shaft of the third fastener configured to engage the second aperture to couple the third fastener to the second fastener.

10. The interconnected battery module of claim 1, wherein in response to a thermal runaway event of a cell in the plurality of cells, the interconnected battery module prevent propagation of the thermal runaway event to a second cell in the adjacent interconnected battery module.

11. An interconnected battery module, comprising:
a first enclosure;
a plurality of cells disposed within the first enclosure; and
a connector assembly extending from a first side of the first enclosure to a second side of the first enclosure, the connector assembly defining a positive electrical terminal and a negative electrical terminal, the connector assembly configured to electrically couple the interconnected battery module to an adjacent interconnected battery module.

12. The interconnected battery module of claim 11, wherein an electrical path is defined from the negative electrical terminal through the plurality of cells to the positive electrical terminal.

13. The interconnected battery module of claim 12, wherein the positive electrical terminal is electrically isolated from the negative electrical terminal through the connector assembly.

14. The interconnected battery module of claim 11, wherein the connector assembly includes a torque driver disposed proximate a first end of the connector assembly and a stud disposed proximate a second end of the connector assembly, the torque driver configured to translate the stud axially in response to the torque driver being rotated about an axis defined by the torque driver.

15. The interconnected battery module of claim 11, wherein the positive electrical terminal is disposed at a first end of the connector assembly and the negative electrical terminal is disposed at a second side of the connector assembly.

16. The interconnected battery module of claim 11, wherein the positive electrical terminal is configured to interface with an adjacent negative electrical terminal of the adjacent interconnected battery module.

17. A battery system, comprising:
a first interconnected battery module including a first vent and a first portion of a gang vent;
a second interconnected battery module disposed adjacent to the first interconnected battery module, the second interconnected battery module including a second vent and a second portion of the gang vent, the second interconnected battery module electrically coupled to the first interconnected battery module, the second interconnected battery module in accordance with the first interconnected battery module.

18. The battery system of claim 17, wherein:
the first interconnected battery module includes a first enclosure defining a first cavity,
the second interconnected battery module includes a second enclosure defining a second cavity, and
the gang vent configured to exhaust ejecta from the first cavity in response to a thermal runaway event of a cell in the first cavity.

19. The battery system of claim 18, wherein:
the first interconnected battery module includes a first plurality of cells disposed in the first cavity; and
the second interconnected battery module includes a second plurality of cells disposed in the second cavity.

20. The battery system of claim 17, wherein:
the first interconnected battery module includes a first connector assembly extending from a first side of the first interconnected battery module to a second side of the first interconnected battery module,
the second interconnected battery module includes a second connector assembly extending from a third side of the second interconnected battery module to a fourth side of the second interconnected battery module, and
a first electrical terminal of the first connector assembly and a second electrical terminal of the second connector assembly define an electrical interface to electrically couple the first interconnected battery module at the second side to the second interconnected battery module and the third side.
